(19) United States
(12) Patent Application Publication
(10) Pub. No.: US 2026/0008284 A1
(43) Pub. Date: Jan. 8, 2026

(54) RECORDING APPARATUS AND CONTROL METHOD THEREOF

(71) Applicant: CANON KABUSHIKI KAISHA, Tokyo (JP)

(72) Inventor: HIKARU WATANABE, Tokyo (JP)

(21) Appl. No.: 19/258,178

(22) Filed: Jul. 2, 2025

(30) Foreign Application Priority Data
Jul. 5, 2024 (JP) 2024-108864

(51) Int. Cl. B41J 15/16; B41J 11/00; B41J 15/02; B41J 15/04

(52) U.S. Cl. CPC B41J 15/16; B41J 11/0095; B41J 15/02; B41J 15/048

(57) ABSTRACT

A recording apparatus includes: a holder that is attached to a winding core of a roll around which a sheet is wound; a locking mechanism that switches between a locked state in which the holder is fixed to the winding core and an unlocked state in which the holder is not fixed to the winding core; a support unit for rotatably supporting the holder; a conveyance unit for conveying the sheet pulled out from the roll; a detection unit for detecting an amount related to a tension applied to the sheet; a control unit for performing drive control of rotation of the holder and driving of the conveyance unit so as to apply a prescribed tension to the sheet pulled out from the roll supported by the support unit; and a notification unit for making a notification based on a detected value of the detection unit during the drive control.

### BACKGROUND

### Field of the Technology

The present disclosure relates to a recording apparatus that records an image on a sheet supplied from a roll, and a control method thereof.

### Description of the Related Art

There is a recording apparatus that records an image on a sheet serving as a recording medium supplied from a roll in which a sheet such paper or a film is wound around a winding core. In such a recording apparatus, a holder including a flange or a core portion is inserted into both ends of the winding core of the roll, the holder is fixed to the winding core, and a shaft portion provided in the holder is attached to a bearing or the like of an apparatus body, whereby the roll is rotatably supported by the apparatus body. There is also a structure in which a shaft member penetrating through the holder and the winding core is attached, and the shaft member is mounted on the bearing or the like. A driving force is transmitted from a driving unit such as a motor of the apparatus body to the holder via a gear provided in the holder, whereby the roll rotates. The sheet pulled out from the roll is conveyed in a state in which an appropriate tension is applied by a conveyance device such as a conveyance roller pair having a nip portion and rotation control of the roll, and recording is performed in a recording unit. As a structure for fixing the holder to the winding core, Japanese Patent No. 3506275 describes putting a plurality of conical pins protruding from the flange into a side surface portion of the winding core.

### SUMMARY

In a state in which the holder is not sufficiently fixed to the winding core, the holder slides with respect to the winding core, and the driving force from the driving unit is not sufficiently transmitted to the roll. In this case, an appropriate tension is not applied to the sheet, and recording quality of the image may be deteriorated.

The present disclosure has been made in view of such a problem, and the present disclosure is directed to provide a recording apparatus capable of prompting a user to take an appropriate measure in a case where a holder is not sufficiently fixed to a winding core.

A recording apparatus that records an image on a sheet according to the present disclosure includes:
a holder that is attached to a winding core of a roll around which the sheet is wound;
a locking mechanism that switches between a locked state in which the holder is fixed to the winding core and an unlocked state in which the holder is not fixed to the winding core;
a support unit for rotatably supporting the holder;
a conveyance unit for conveying the sheet pulled out from the roll supported by the support unit;
a detection unit for detecting an amount related to a tension applied to the sheet;
a control unit for performing drive control of rotation of the holder and driving of the conveyance unit so as to apply a prescribed tension to the sheet pulled out from the roll supported by the support unit; and
a notification unit for making a notification based on a detected value of the detection unit during the drive control.

A control method of a recording apparatus according to the present disclosure:
the recording apparatus comprising:
a holder that is attached to a winding core of a roll around which the sheet is wound;
a locking mechanism that switches between a locked state in which the holder is fixed to the winding core and an unlocked state in which the holder is not fixed to the winding core;
a support unit for rotatably supporting the holder;
a conveyance unit for conveying the sheet pulled out from the roll supported by the support unit; and
a detection unit for detecting an amount related to a tension applied to the sheet, wherein
the control method comprising:
a step of performing drive control of rotation of the holder and driving of the conveyance unit so as to apply a prescribed tension to the sheet pulled out from the roll supported by the support unit;
a detection step of detecting, by the detection unit, an amount related to the tension applied to the sheet during the drive control; and
a notification step of making a notification based on a detected value in the detection step.

Features of the present disclosure will become apparent from the following description of embodiments with reference to the attached drawings. The following description of embodiments are described by way of example.

### BRIEF DESCRIPTION OF THE DRAWINGS

FIG. 1A is a perspective view illustrating a recording apparatus in a state in which the cover is closed.

FIG. 1B is a perspective view illustrating a recording apparatus in a state in which the cover 50 is opened.

FIG. 2 is a cross-sectional view illustrating the recording apparatus.

FIG. 3 is a top view illustrating the recording apparatus.

FIG. 4 is a block diagram illustrating a control configuration of the recording apparatus.

FIG. 5A is a view for describing a method of setting the reference side flange and the non-reference side flange on the roll.

FIG. 5B is a view illustrating a state in which the reference side flange and the non-reference side flange are set on the roll.

FIG. 6 is a perspective view illustrating a reference side flange.

FIG. 7A is a perspective view illustrating a first contact portion.

FIG. 7B is a perspective view illustrating a second contact portion.

FIG. 8 is a perspective view of a cam member.

FIG. 9A is a cross-sectional view of the reference side flange passing through the rotation axis of the roll when viewed from a radial direction of the roll in a case where the cam member is at the first position.

FIG. 9B is a cross-sectional view of the reference side flange passing through the rotation axis of the roll when viewed from a radial direction of the roll in a case where the cam member is at the second position.

FIG. 9C is a cross-sectional view of the reference side flange taken along a cross section perpendicular to the rotation axis when viewed in the rotation axis direction of the roll in a case where the cam member is at the first position.

FIG. 9D is a cross-sectional view of the reference side flange taken along a cross section perpendicular to the rotation axis when viewed in the rotation axis direction of the roll in a case where the cam member is at the second position.

FIG. 10A is a radial cross-sectional view of the reference side flange in a case where the cam member is at the first position.

FIG. 10B is a radial cross-sectional view of the reference side flange in a case where the cam member is at the second position.

FIG. 10C is a cross-sectional view of the reference side flange in the rotation axis direction in a case where the cam member is at the first position.

FIG. 10D is a cross-sectional view of the reference side flange in the rotation axis direction in a case where the cam member is at the second position.

FIG. 11A is a view illustrating a state in which the roll to which the reference side flange and the non-reference side flange are attached is set in the recording apparatus.

FIG. 11B is a view illustrating a state in which the roll to which the reference side flange and the non-reference side flange are attached is set in the recording apparatus.

FIG. 12A is a perspective view of a non-reference side portion of the roll setting portion of the recording apparatus.

FIG. 12B is a perspective view illustrating a position of a non-reference side bearing member in the case of setting the roll with a large sheet width in the roll setting portion of the recording apparatus.

FIG. 12C is a perspective view illustrating a position of the non-reference side bearing member in the case of setting the roll with a small sheet width in the roll setting portion of the recording apparatus.

FIG. 13 is a view illustrating a reference side bearing.

FIG. 14A is a view illustrating a state in which the roll to which the reference side flange and the non-reference side flange are attached is set in the recording apparatus in a case where the non-reference side bearing member is attached to the third positioning hole.

FIG. 14B is a view illustrating a state in which the roll to which the reference side flange and the non-reference side flange are attached is set in the recording apparatus in a case where the non-reference side bearing member is attached to the third positioning hole.

FIG. 15A a graph illustrating a torque change in a case where the reference side flange attached to the roll is in the locked state in which the reference side flange is normally fixed.

FIG. 15B is a graph illustrating a torque change in a roll end state in which the remaining sheet in the roll has run out.

FIG. 15C is a graph illustrating a torque change in a case where the roll is unwound and is brought into the roll end state when the tension is applied to the sheet by the tension applying control in a state immediately before the roll end state, in which about one turn of the sheet remains on the winding core.

FIG. 15D is a graph illustrating a torque change in a case where the reference side flange attached to the roll is in the unlocked state.

FIG. 16 is a flowchart illustrating a flow of the determination processing.

FIG. 17A is a graph illustrating a change in flange rotation speed in a case where the reference side flange is in a locked state.

FIG. 17B is a graph illustrating a change in flange rotation speed in a roll end state.

FIG. 17C is a graph illustrating a change in flange rotation speed in a case where the roll 201 is unwound.

FIG. 17D is a graph illustrating a change in flange rotation speed in a case where the reference side flange is in an unlocked state.

FIG. 18 is a flowchart illustrating a flow of the determination processing.

FIG. 19A is a view illustrating a screen display example in a case where it is determined that the roll end state has occurred by the determination processing.

FIG. 19B is a view illustrating a screen display example in a case where it is determined that the reference side flange is in the unlocked state by the determination processing.

FIG. 19C is a view illustrating a screen display example for guiding a roll setting method and a flange locking method.

FIG. 20 is a flowchart illustrating a flow of the determination processing.

### DESCRIPTION OF THE EMBODIMENTS

Hereinafter, exemplary embodiments for carrying out the present disclosure will be described with reference to the drawings. However, the dimensions, materials, shapes, relative arrangement and the like of the components described in the following examples may be modified as appropriate depending on the configuration and various conditions of the device to which the present disclosure is applied, and are not intended to limit the scope of the present disclosure to the following examples.

### First Embodiment

### Operation of Recording Apparatus

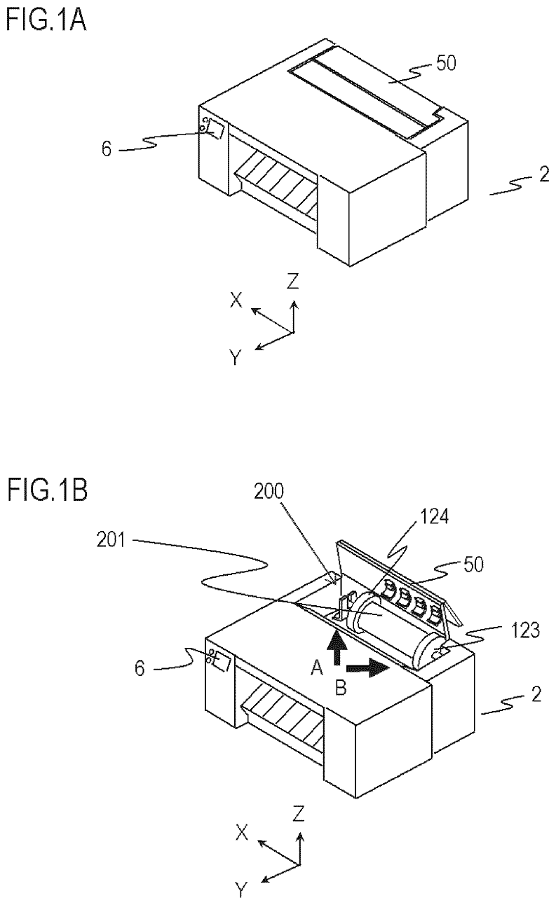

A schematic configuration of a recording apparatus 2 will be described with reference to FIGS. 1A and 1B. FIGS. 1A and 1B are perspective views schematically illustrating the recording apparatus 2 of a first embodiment. The recording apparatus 2 is an inkjet recording apparatus that holds a roll (roll paper or roll sheet) in which a sheet serving as a recording medium is wound around a hollow winding core and records an image on the sheet supplied from the roll. In the first embodiment, an example in which the present disclosure is applied to an inkjet recording apparatus will be described, but the present disclosure can be applied to any recording apparatus that records an image on a sheet supplied from a roll, and a recording method (printing method) is not limited to an inkjet method. In the following description, a direction parallel to a rotation axis direction (central axis direction) of the winding core of the roll is defined as an X direction, a direction parallel to the rotation axis direction and parallel to a horizontal direction is defined as a Y direction, and a direction perpendicular to the X direction and the Y direction is defined as a Z direction. The X direction is a sheet width direction, the Y direction is a sheet conveyance direction, and the Z direction is a vertical direction in a case where the recording apparatus 2 is installed on a horizontal plane.

The recording apparatus 2 includes an operation panel 6 and a cover 50. The operation panel 6 includes an operation portion operable by a user, such as a button or a touch panel, and a display portion (display unit) such as a liquid crystal display. The user can input a command such as an operation setting to the recording apparatus 2 by operating the operation portion. Information such as an operation state of the recording apparatus 2 is displayed on the display portion. The display portion is a notification unit for notifying of information such as the operation state of the recording apparatus 2. The user can check the operation state and the like of the recording apparatus 2 by viewing the display on the display portion.

The cover 50 is provided on a back side (−Y direction side) of the recording apparatus 2 so as to be openable and closeable. FIG. 1A illustrates the recording apparatus 2 in a state in which the cover 50 is closed, and FIG. 1B illustrates the recording apparatus 2 in a state in which the cover 50 is opened. When the cover 50 is opened, a roll setting portion 200 of the recording apparatus 2 is exposed. The roll setting portion 200 is a support unit for rotatably supporting a reference side flange 123 and a non-reference side flange 124. As illustrated in FIG. 1B, when the cover 50 is opened, a roll 201 can be set in the roll setting portion 200 of an apparatus body of the recording apparatus 2. It is possible to prevent dust and debris from being attached to the roll 201 and prevent foreign matter from entering the inside of the recording apparatus 2 by closing the cover 50 as illustrated in FIG. 1A after the roll 201 is set in the roll setting portion 200.

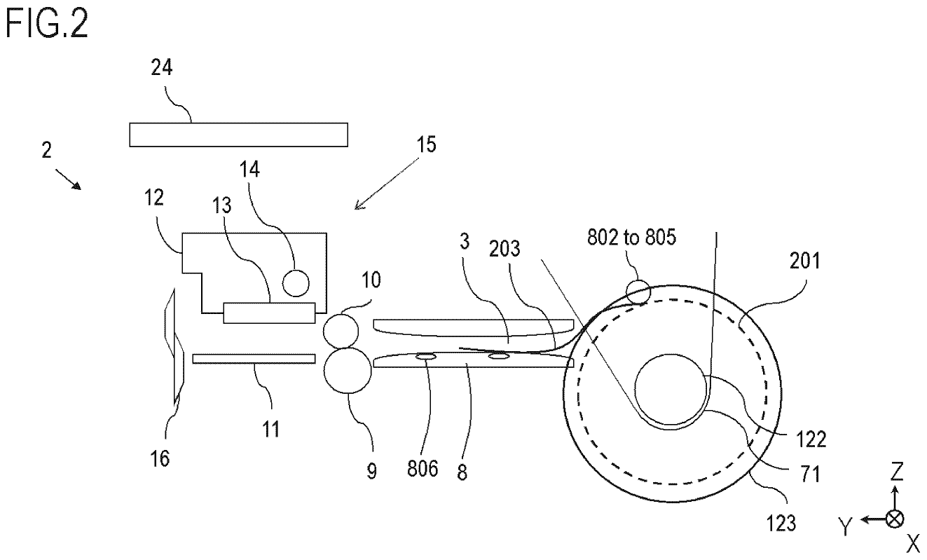

A schematic configuration of the recording apparatus 2 will be described with reference to FIG. 2. FIG. 2 is a cross-sectional view schematically illustrating the recording apparatus 2 of the first embodiment.

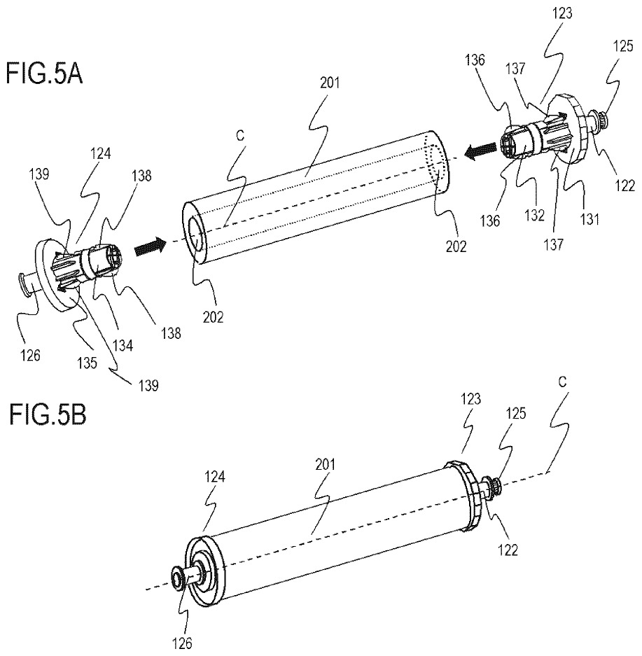

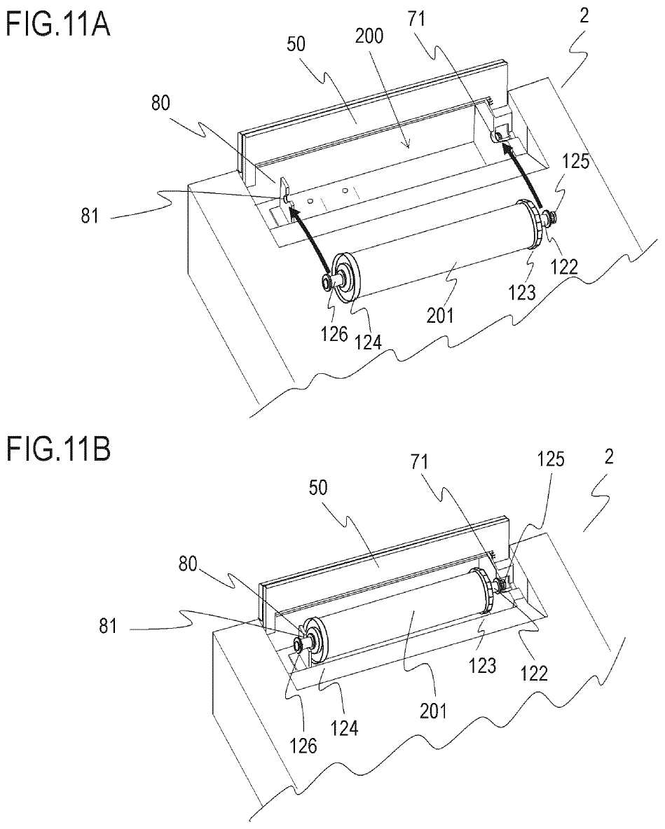

The recording apparatus 2 can record an image on a sheet 203 serving as the recording medium pulled out from the roll 201. A reference side flange 123 and a non-reference side flange 124 (see FIG. 5A) which are holders are attached to a hollow winding core 202 (see FIG. 5A) of the roll 201 around which the sheet is wound. The roll 201 to which the reference side flange 123 and the non-reference side flange 124 are attached is rotatably supported by a reference side bearing 71 and a non-reference side bearing 81 of the roll setting portion 200 provided in the apparatus body of the recording apparatus 2 (see FIGS. 11A and 11B). After setting the roll 201 in the roll setting portion 200, the user can pull out the sheet 203 from the roll 201 and manually feed the sheet 203 to a downstream side in the conveyance direction (Y direction) along a lower guide 8 of a conveyance passage 3.

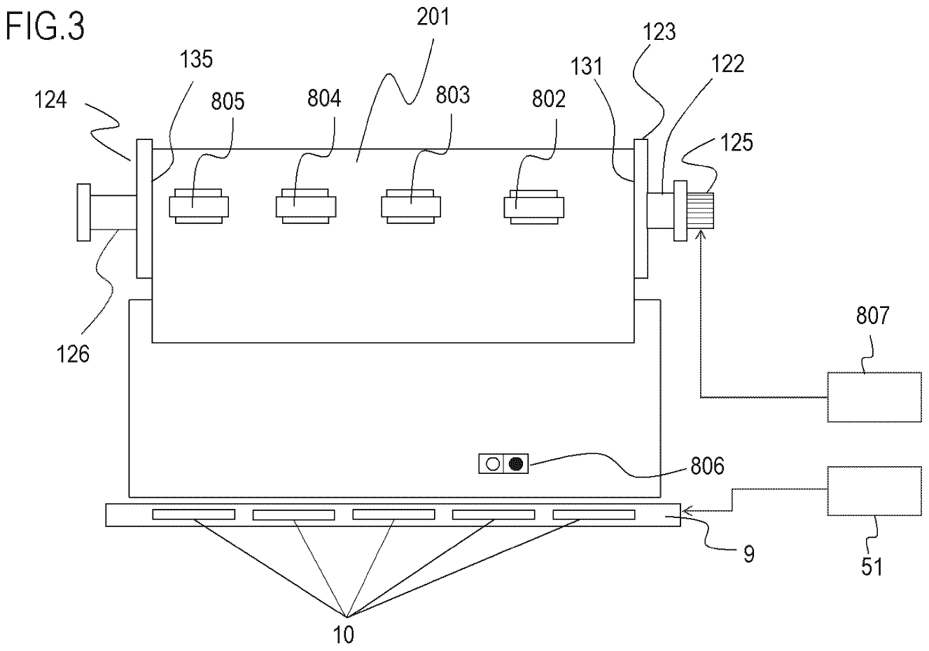

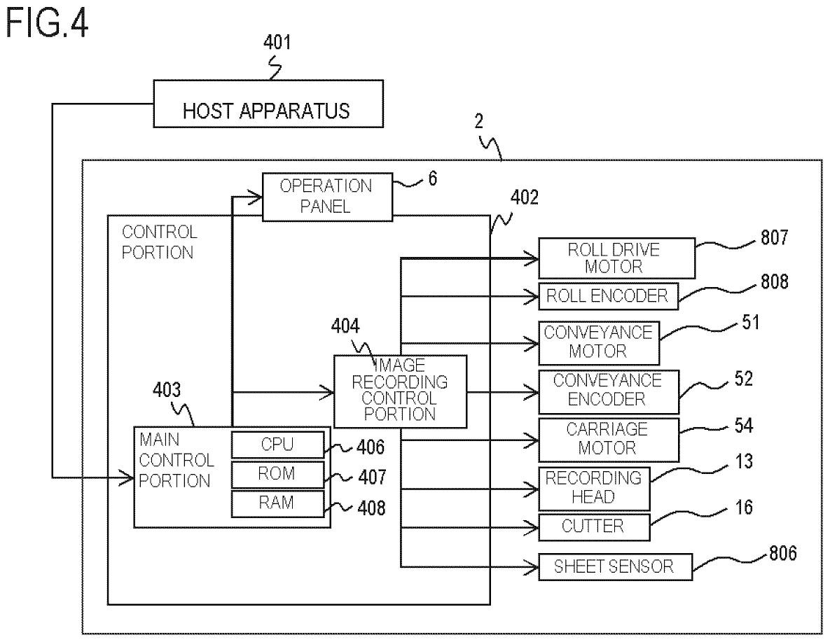

A setting operation for the roll 201 will be described with reference to FIG. 3. When the user manually feeds the roll 201 to the downstream side in the conveyance direction along the conveyance passage 3, and a leading edge of the sheet 203 reaches a sheet sensor 806 installed in the convey passage 3, a control portion 402 (see FIG. 4) notifies that the sheet 203 has reached the sheet sensor 806. Various known methods can be used as the notification unit. For example, the user can be notified by sound from a buzzer, sound from a speaker, lighting or blinking of light of a lamp, or the like.

After the leading edge of the sheet 203 reaches the sheet sensor 806, a sheet feeding operation is automatically performed by rotation of the roll 201 by a roll drive motor 807 and rotation of a conveyance roller 9 and a driven roller 10 by a conveyance motor 51. The user can end the manual sheet feeding operation and close the cover 50 by confirming the notification.

Pressing rollers 802, 803, 804, and 805 are attached to the cover 50. When the cover 50 is closed, the pressing rollers 802, 803, 804, and 805 press the roll 201. In the recording apparatus 2 of the first embodiment, since the pressing rollers 802 to 805 are provided on the cover 50, a state of pressing the roll 201 and a state of not pressing the roll are switched in conjunction with the opening and closing of the cover 50.

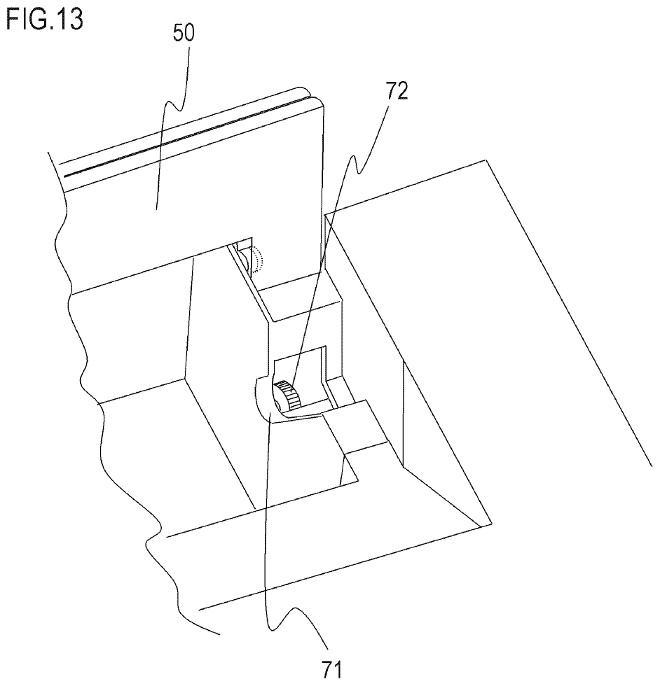

A flange gear 125 is provided at an end portion of a reference side (−X direction side) of the reference side flange 123 attached to a reference side end portion of the winding core 202 of the roll 201. In a state in which the roll 201 is supported by the roll setting portion 200, the flange gear 125 meshes with a drive gear 72 (see FIG. 13) provided in the apparatus body of the recording apparatus 2. The drive gear 72 is connected to the roll drive motor 807. A driving force of the roll drive motor 807 is transmitted to the reference side flange 123 via the drive gear 72 and the flange gear 125, whereby the roll 201 is rotatable.

The roll 201 can rotate in a forward direction (forward rotation) and in a reverse direction (reverse rotation) according to control of a rotation direction of the roll drive motor 807. The forward rotation is rotation in a direction in which the sheet 203 is supplied from the roll 201 to the conveyance passage 3, and the reverse rotation is rotation in a direction in which the sheet 203 is wound around the roll 201. By rotating the roll 201 in the forward direction or the reverse direction, the sheet 203 can be conveyed in the forward direction or the reverse direction in the conveyance passage 3.

After the sheet 203 reaches the sheet sensor 806, and the cover 50 is closed, the control portion 402 controls the roll drive motor 807 to transmit the driving force to the flange gear 125 to rotate the roll 201 in the forward direction. As a result, the leading edge of the sheet 203 is conveyed to a nip portion of a conveyance roller pair including the conveyance roller 9 and the driven roller 10. A conveyance force of the roll 201 at this time is generated by a pressing force of the pressing rollers 802 to 805.

When the leading edge of the sheet 203 reaches the nip portion between the conveyance roller 9 and the driven roller 10, the control portion 402 controls the conveyance motor 51 to transmit the driving force to the conveyance roller 9 to rotate the conveyance roller 9 in the forward direction. As a result, the sheet 203 is nipped between the conveyance roller 9 and the driven roller 10. The roll drive motor 807 is first driving unit for rotationally driving the reference side flange 123 including the flange gear 125. The conveyance motor 51 is second driving unit for rotationally driving the conveyance roller 9 serving as conveyance unit.

Next, the control portion 402 performs drive control (hereinafter, referred to as tension applying control) to control the roll drive motor 807 and the conveyance motor 51 so as to apply a prescribed tension to the sheet 203 pulled out from the roll 201 supported by the roll setting portion 200. The prescribed tension is a tension that enables a recording operation of recording an image on the sheet 203 to be appropriately performed while conveying the sheet 203 pulled out from the roll 201.

In the tension applying control, the control portion 402 controls the roll drive motor 807 and the conveyance motor 51 to stop the conveyance roller 9 and rotate the roll 201 in the reverse direction in a state in which the sheet 203 is nipped between the conveyance roller 9 and the driven roller 10. In other words, the reference side flange 123 is rotated in a direction in which the sheet 203 is wound around the roll 201.

In the tension applying control, the control portion 402 may control the roll drive motor 807 and the conveyance motor 51 to rotate the conveyance roller 9 in the forward direction and stop the roll 201 in a state in which the sheet 203 is nipped between the conveyance roller 9 and the driven roller 10. In other words, the conveyance roller 9 may be rotated in a direction in which the sheet 203 is pulled out from the roll 201.

By performing the tension applying control, the control portion 402 determines whether or not the roll 201 is normally set in the recording apparatus 2, and notifies of a determination result. Details of the determination are described below. In a case where the roll 201 is normally set, the sheet 203 is conveyed to a recording portion 15 by rotating the conveyance roller 9 in the forward direction in this state.

The recording portion 15 includes a carriage 12, a recording head 13, and a carriage shaft 14. A platen 11 is provided so as to face the recording head 13. The platen 11 guides the sheet 203 in a state of supporting the sheet 203 from a back surface in the recording portion 15. As a result, an appropriate gap is secured between the recording head 13 and the sheet 203.

The recording head 13 serving as recording unit is mounted on the carriage 12, and the carriage 12 is supported by the carriage shaft 14 serving as a scanning guide extending in the X direction so as to be capable of reciprocating in a ±X direction (main scanning direction). In the recording head 13, a plurality of ejection ports (nozzles) for ejecting ink are arranged in the Y direction, and the plurality of ejection ports eject the ink in a −Z direction according to image data while the carriage 12 moves.

When an image for one line is recorded on the sheet 203 by an ejection operation of the recording head 13 and the movement of the carriage 12, the conveyance roller 9 and the driven roller 10 are driven to convey the sheet 203 at a predetermined pitch in the conveyance direction Y. Then, the carriage 12 is moved during the ejection operation of the recording head 13 to record an image of the next line. By repeating such an operation, the image is recorded on the entire page.

A cutter 16 is provided downstream of the recording portion 15 in the conveyance direction Y and can cut the sheet 203 to a predetermined length. Note that the image recording operation in the case of using cut paper as the recording medium is also similar to that in the case of performing image recording on the sheet 203 supplied from the roll 201. An openable and closable upper cover 24 is provided above the recording portion 15.

Next, a control configuration of the recording apparatus 2 will be described with reference to FIG. 4. FIG. 4 is a block diagram illustrating a control configuration of the recording apparatus 2 of the first embodiment.

An external host apparatus 401 is connected to the recording apparatus 2. The host apparatus 401 transmits an image recording command generated by the host apparatus 401 to the recording apparatus 2. The recording apparatus 2 includes the control portion 402 that controls an operation of the recording apparatus 2. The control portion 402 mainly includes a main control portion 403 and an image recording control portion 404. The main control portion 403 includes a CPU 406 serving as calculation unit, and a ROM 407 and a RAM 408 serving as storage unit. In the main control portion 403, the CPU 406 outputs an instruction for controlling the operation of the recording apparatus 2 while using the RAM 408 as a work area according to various programs and parameters stored in the ROM 407.

The image recording control portion 404 communicates with the roll drive motor 807, a roll encoder 808, the conveyance motor 51, a conveyance encoder 52, a carriage motor 54, the recording head 13, the cutter 16, the sheet sensor 806, and the like. Then, operations thereof are controlled on the basis of an instruction from the main control portion 403. The main control portion 403 outputs information indicating the determination result, the operation state of the recording apparatus 2, and the like to the operation panel 6 and displays the information on the display portion, thereby notifying of the information.

The conveyance encoder 52 is provided in a drive train connected to the conveyance motor 51, and the roll encoder 808 is provided in a drive train connected to the roll drive motor 807. Outputs of the conveyance encoder 52 and the roll encoder 808 are input to the image recording control unit 404. The image recording control portion 404 detects information such as rotation amounts, rotation speeds, and positions of the reference side flange 123 and the conveyance roller 9 based on inputs from the conveyance encoder 52 and the roll encoder 808, and performs control based on the information.

### Setting of Flange on Winding Core

FIG. 5A is a view for describing a method of setting the reference side flange 123 and the non-reference side flange 124 on the roll 201. FIG. 5B is a view illustrating a state in which the reference side flange 123 and the non-reference side flange 124 are set on the roll 201.

The reference side flange 123 includes a reference side flange surface 131, a reference side core portion 132, a reference side shaft portion 122, the flange gear 125, a first contact portion 136, and a second contact portion 137. The reference side flange surface 131 is formed of a flat surface. The reference side core portion 132 protrudes from the reference side flange surface 131 and can be inserted into the winding core 202 of the roll 201. The reference side shaft portion 122 protrudes in a direction opposite to the reference side core portion 132, and is rotatably supported by the reference side bearing 71 of the roll setting portion 200 serving as a support member. The flange gear 125 is provided at an end portion of the reference side shaft portion 122, and the driving force of the roll drive motor 807 is transmitted. The first contact portion 136 is provided in the vicinity of a distal end portion of the reference side core portion 132 away from the reference side flange surface 131, and the second contact portion 137 is provided in the vicinity of a base portion of the reference side core portion 132 close to the reference side flange surface 131. Each of the first contact portion 136 and the second contact portion 137 comes into contact with an inner peripheral surface of a hollow portion of the winding core 202 of the roll 201, whereby the reference side core portion 132 is fitted to the winding core 202.

The non-reference side flange 124 includes a non-reference side flange surface 135, a non-reference side core portion 134, a non-reference side shaft portion 126, a first contact portion 138, and a second contact portion 139. The non-reference side flange surface 135 is formed of a curved surface. The non-reference side core portion 134 protrudes from the non-reference side flange surface 135, and can be inserted into the winding core 202 of the roll 201. The non-reference side shaft portion 126 protrudes in a direction opposite to the non-reference side core portion 134, and is rotatably supported by the non-reference side bearing 81 of the roll setting portion 200 serving as the support member. The first contact portion 138 is provided in the vicinity of a distal end portion of the non-reference side core portion 134 away from the non-reference side flange surface 135, and the second contact portion 139 is provided in the vicinity of a base portion of the non-reference side core portion 134 close to the non-reference side flange surface 135. Each of the first contact portion 138 and the second contact portion 139 comes into contact with the inner peripheral surface of the hollow portion of the winding core 202 of the roll 201, whereby the non-reference side core portion 134 is fitted to the winding core 202.

The reference side flange 123 and the non-reference side flange 124 can be switched between a locked state in which the reference side flange 123 and the non-reference side flange 124 are fixed to the winding core 202 of the roll 201 and an unlocked state in which the reference side flange 123 and the non-reference side flange 124 are not fixed to the winding core 202 of the roll 201. In the unlocked state, the reference side flange 123 and the non-reference side flange 124 are detachable from the winding core 202. The reference side flange 123 and the non-reference side flange 124 include a locking mechanism capable of switching between the locked state and the unlocked state.

When attaching the reference side flange 123 and the non-reference side flange 124 to the roll 201, first, the reference side core portion 132 and the non-reference side core portion 134 are inserted into the winding core 202 of the roll 201. Next, the reference side flange 123 and the non-reference side flange 124 are fixed to the winding core 202 by the locking mechanism. In a state in which the reference side flange 123 and the non-reference side flange 124 are fixed to the roll 201, central axes of the reference side shaft portion 122, the flange gear 125, the reference side core portion 132, and the non-reference side core portion 134 are parallel to a rotation axis C of the roll 201 (a rotation axis of the winding core 202).

### Locking Mechanism

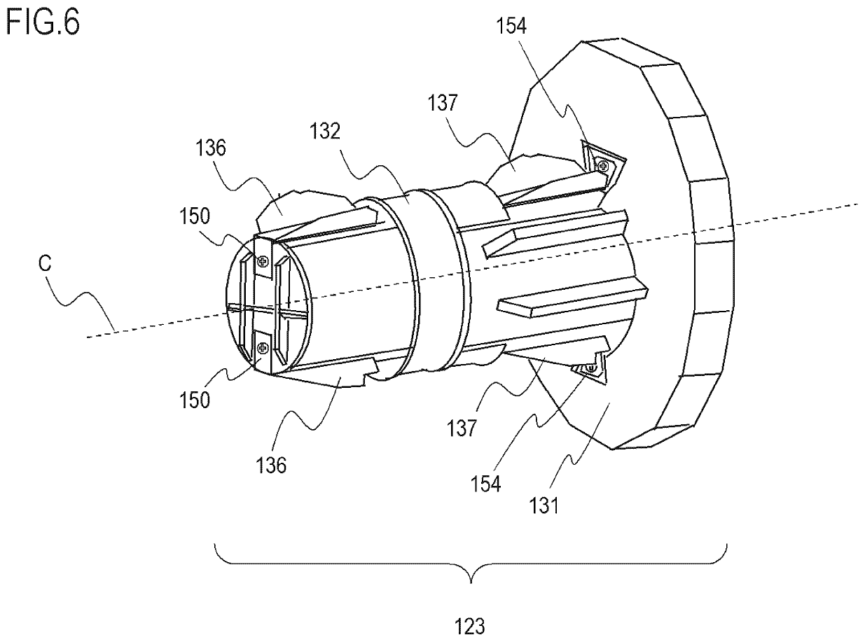

The locking mechanism will be described. FIG. 6 is a perspective view illustrating the reference side flange 123.

The first contact portion 136 is provided at the distal end portion of the reference side core portion 132 away from the reference side flange surface 131. The second contact portion 137 is provided at the base portion of the reference side core portion 132 close to the reference side flange surface 131. Two first contact portions 136 are provided at symmetrical positions with respect to the rotation axis C of the roll 201. Two second contact portions 137 are provided at symmetrical positions with respect to the rotation axis C of the roll 201.

The first contact portion 136 is fixed to the distal end portion of the reference side core portion 132 of the reference side flange 123 by a first fixing portion 150. The second contact portion 137 is fixed to the reference side flange surface 131 of the reference side flange 123 by a second fixing portion 154.

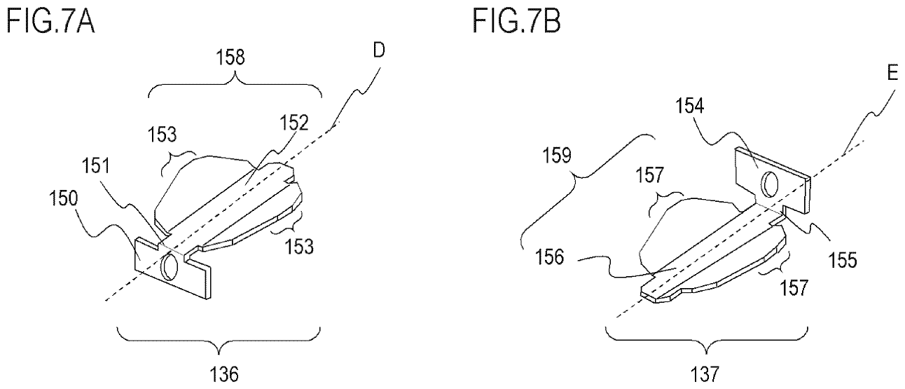

FIGS. 7A and 7B are perspective views illustrating the first contact portion 136 and the second contact portion 137.

The first contact portion 136 includes the first fixing portion 150, a first connection portion 151, a first flat surface portion 152, and first interference portions 153. The first flat surface portion 152 is a surface pressed by a first pressing portion 161 described below. The first interference portions 153 are provided on both sides across a center line D parallel to the rotation axis C of the first flat surface portion 152. The first connection portion 151 connects the first flat surface portion 152 and the first fixing portion 150. A width of the first connection portion 151 in a direction perpendicular to the center line D is smaller than a width of the first fixing portion 150 and smaller than a width of a first movable portion 158 including the first flat surface portion 152 and the first interference portions 153. In a case where the reference side flange 123 is attached to the winding core 202 of the roll 201, the first interference portions 153 come into contact with an inner peripheral surface of the winding core 202.

The second contact portion 137 includes the second fixing portion 154, a second connection portion 155, a second flat surface portion 156, and second interference portions 157. The second flat surface portion 156 is a surface pressed by a second pressing portion 162 described below. The second interference portions 157 are provided on both sides across a center line E parallel to the rotation axis C of the second flat surface portion 156. The second connection portion 155 connects the second flat surface portion 156 and the second fixing portion 154. A width of the second connection portion 155 in a direction perpendicular to the center line E is smaller than a width of the second fixing portion 154 and smaller than a width of a second movable portion 159 including the second flat surface portion 156 and the second interference portions 157. In a case where the reference side flange 123 is attached to the winding core 202 of the roll 201, the second interference portion 157 comes into contact with the inner peripheral surface of the winding core 202.

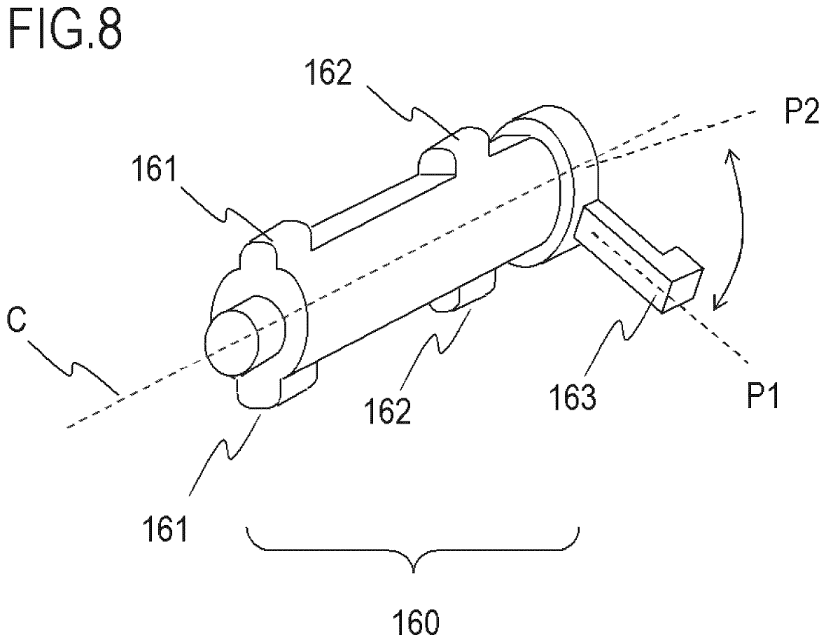

FIG. 8 is a perspective view illustrating a cam member 160. The cam member 160 is provided inside of the reference side flange 123. The cam member 160 includes the first pressing portion 161, the second pressing portion 162, and a lever 163. The cam member 160 is movable between a first position P1 and a second position P2 by rotating around the rotation axis C of the winding core 202 in a state in which the reference side flange 123 is inserted into the winding core 202. The user can move a position of the cam member 160 between the first position P1 and the second position P2 by operating the lever 163 of the cam member 160.

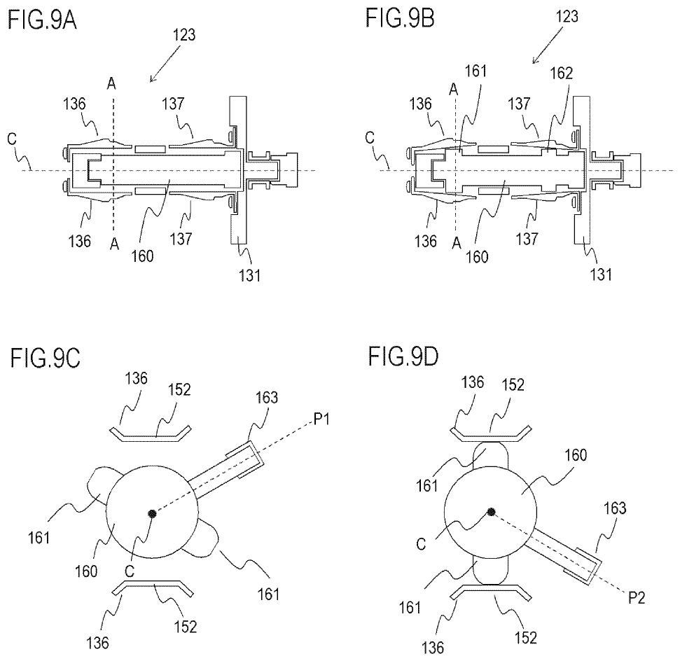

FIGS. 9A and 9B are cross-sectional views (radial cross-sectional views) of the reference side flange 123 passing through the rotation axis C of the roll 201 when viewed from a radial direction of the roll 201. FIGS. 9C and 9D illustrate cross sections taken along line AA of FIGS. 9A and 9B, and are cross-sectional views (cross-sectional views in the rotation axis direction) of the reference side flange 123 taken along a cross section perpendicular to the rotation axis C when viewed in the rotation axis direction of the roll 201. A positional relationship between the reference side flange 123 and the rotation axis C of the roll 201 in FIGS. 9A to 9D is a positional relationship in a state in which the reference side flange 123 is attached to the winding core 202 of the roll 201. FIGS. 9A and 9C illustrate a case where the cam member 160 is at the first position P1, and FIGS. 9B and 9D illustrate a case where the cam member 160 is at the second position P2.

When the cam member 160 is at the first position P1, the first pressing portion 161 does not come into contact with the first flat surface portion 152 of the first contact portion 136, and the second pressing portion 162 is in a posture in which the second pressing portion 162 does not come into contact with the second flat surface portion 156 of the second contact portion 137. When the cam member 160 is at the second position P2, the first pressing portion 161 presses the first flat surface portion 152 of the first contact portion 136, and the second pressing portion 162 presses the second flat surface portion 156 of the second contact portion 137. FIGS. 9C and 9D are views illustrating a cross section including the first pressing portion 161 and the first contact portion 136, and the same applies to a cross section including the second pressing portion 162 and the second contact portion 137.

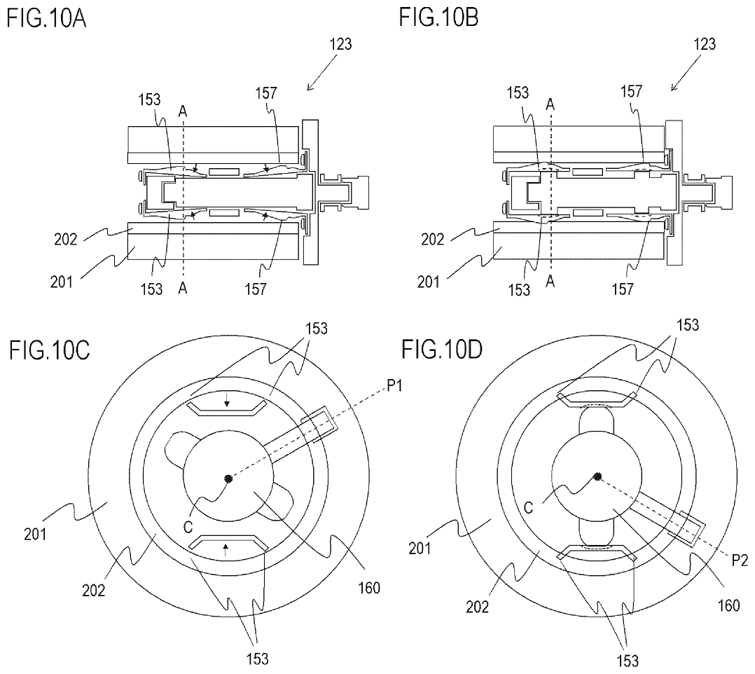

FIGS. 10A and 10B are radial cross-sectional views of the reference side flange 123, and FIGS. 10C and 10D are cross-sectional views of the reference side flange 123 in the rotation axis direction at positions indicated by line AA in FIGS. 10A and 10B. FIGS. 10A and 10C illustrate a case where the cam member 160 is at the first position P1, and FIGS. 10B and 10D illustrate a case where the cam member 160 is at the second position P2.

As illustrated in FIGS. 10A and 10C, when the reference side flange 123 is attached to the roll 201, the cam member 160 is moved to the first position P1. When the reference side core portion 132 of the reference side flange 123 is inserted into the winding core 202 of the roll 201, the first interference portions 153 and the second interference portions 157 come into contact with the inner peripheral surface of the winding core 202 of the roll 201 and receive a reaction force from the inner peripheral surface. As a result, the first movable portion 158 of the first contact portion 136 and the second movable portion 159 of the second contact portion 137 are deformed so as to be retracted from the inner peripheral surface of the winding core 202.

Here, as described with reference to FIGS. 7A and 7B, the width of the first connection portion 151 in the first contact portion 136 is smaller than the widths of the first fixing portion 150 and the first movable portion 158. The width of the second connection portion 155 in the second contact portion 137 is smaller than the widths of the second fixing portion 154 and the second movable portion 159. Therefore, in a case where the first interference portion 153 and the second interference portion 157 come into contact with the inner peripheral surface of the winding core 202, a force required for the first movable portion 158 and the second movable portion 159 to be deformed so as to be retracted from the inner peripheral surface of the winding core 202 is small. Accordingly, a frictional force between the first interference portions 153 and the second interference portions 157 and the inner peripheral surface of the winding core 202 of the roll 201 can be reduced. As a result, a load of an operation of attaching the reference side flange 123 to the roll 201 is reduced, and operability is improved.

After the reference side flange 123 is inserted into the roll 201, the cam member 160 is moved to the second position P2 as illustrated in FIGS. 10B and 10D. At the second position P2, the first pressing portion 161 presses the first flat surface portion 152 of the first contact portion 136, and the second pressing portion 162 presses the second flat surface portion 156 of the second contact portion 137. Then, the first interference portions 153 and the second interference portions 157 come into contact with the inner peripheral surface of the winding core 202 of the roll 201, and press the inner peripheral surface radially outward. As a result, the reference side flange 123 is fixed to the winding core 202 of the roll 201.

When the cam member 160 is at the second position P2, as illustrated in FIG. 10D, the first contact portion 136 and the second contact portion 137 are at a pressing position where the first contact portion 136 and the second contact portion 137 come into contact with the inner peripheral surface of the winding core 202 of the roll 201 to press the inner peripheral surface radially outward. When the cam member 160 is at the first position P1, as illustrated in FIG. 10C, the first contact portion 136 and the second contact portion 137 are at a non-pressing position on a radially inner side of the pressing position. The cam member 160 moves the first contact portion 136 and the second contact portion 137 between the pressing position and the non-pressing position.

By moving the first contact portion 136 and the second contact portion 137 to the pressing position by the cam member 160, the first contact portion 136 and the second contact portion 137 of the reference side flange 123 are pressed against the inner peripheral surface of the winding core 202, and the reference side flange 123 is brought into a locked state.

By moving the first contact portion 136 and the second contact portion 137 to the non-pressing position by the cam member 160, the reference side flange 123 is brought into an unlocked state in which the first contact portion 136 and the second contact portion 137 are not pressed against the inner peripheral surface of the winding core 202.

The first contact portion 136 and the second contact portion 137 are made of an elastic body. Since the first contact portion 136 and the second contact portion 137 are elastically deformed, variations in an inner diameter of the winding core 202 of the roll 201 can be absorbed. As a result, the reference side flange 123 is reliably fixed to the winding core 202 of the roll 201, and slippage between the reference side flange 123 and the roll 201 can be suppressed.

A state in which the reference side flange 123 is attached to the winding core 202 and the cam member 160 is moved to the second position P2 is the locked state in which the reference side flange 123 is fixed to the winding core 202. A state in which the cam member 160 is moved to the first position P1 is the unlocked state in which the reference side flange 123 is not fixed to the winding core 202.

The non-reference side flange 124 also has the same structure as the reference side flange 123 described above, and can switch between the locked state and the unlocked state.

### Setting of Roll in Recording Apparatus

FIG. 11A is a view illustrating a state in which the roll 201 to which the reference side flange 123 and the non-reference side flange 124 are attached is set in the recording apparatus 2. FIG. 11B is a view illustrating a state in which the roll 201 to which the reference side flange 123 and the non-reference side flange 124 are attached is set in the recording apparatus 2.

As illustrated in FIG. 11A, the roll 201 is set in the roll setting portion 200 of the recording apparatus 2 such that the reference side bearing 71 supports the reference side shaft portion 122 and the non-reference side bearing 81 supports the non-reference side shaft portion 126. The user can perform the operation such that the reference side shaft portion 122 approaches the reference side bearing 71 and the non-reference side shaft portion 126 approaches the non-reference side bearing 81.

As illustrated in FIG. 11A, the reference side bearing 71 and the non-reference side bearing 81 are opened in a direction in which the roll 201 approaches. As illustrated in FIG. 11B, even in a state in which the roll 201 is set in the recording apparatus 2, an engagement state between the reference side shaft portion 122 and the reference side bearing 71 and an engagement state between the non-reference side shaft portion 126 and the non-reference side bearing 81 can be visually observed. Therefore, even in a state in which the reference side shaft portion 122 approaches the reference side bearing 71 and the non-reference side shaft portion 126 approaches the non-reference side bearing 81 during the setting operation, the user can easily visually recognize the reference side bearing 71 and the non-reference side bearing 81. Therefore, operability in alignment between the reference side shaft portion 122 and the reference side bearing 71 and alignment between the non-reference side shaft portion 126 and the non-reference side bearing 81 in the setting operation is favorable.

### Setting of Rolls With Various Sheet Widths

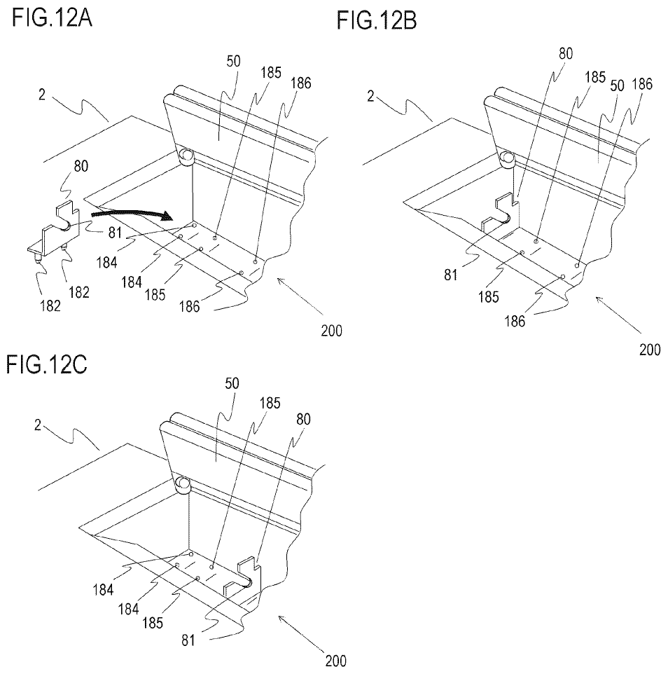

FIGS. 12A, 12B, and 12C are views when viewed in a direction of an arrow A in FIG. 1B. FIG. 12A is a perspective view of a non-reference side portion of the roll setting portion 200 of the recording apparatus 2. FIG. 12B is a perspective view illustrating a position of a non-reference side bearing member 80 in the case of setting the roll 201 with a large sheet width in the roll setting portion 200 of the recording apparatus 2. FIG. 12C is a perspective view illustrating a position of the non-reference side bearing member 80 in the case of setting the roll 201 with a small sheet width in the roll setting portion 200 of the recording apparatus 2.

The non-reference side bearing member 80 is a member provided with the non-reference side bearing 81 that rotatably supports the non-reference side shaft portion 126 of the non-reference side flange 124. The non-reference side bearing 81 is formed in a U shape and is opened in a direction in which the roll 201 approaches in the setting operation for the roll 201, and the non-reference side shaft portion 126 can be fitted from the opening.

The non-reference side bearing member 80 includes positioning portions 182 implemented by protrusions protruding downward. In addition, the roll setting portion 200 of the recording apparatus 2 is provided with a first positioning hole 184, a second positioning hole 185, and a third positioning hole 186 implemented by depressed portions into which the positioning portions 182 can be fitted. The first positioning hole 184, the second positioning hole 185, and the third positioning hole 186 are provided at different positions in the X direction (sheet width direction).

The first positioning hole 184, the second positioning hole 185, and the third positioning hole 186 are respectively provided at positions corresponding to the sheet width of the roll 201 assumed to be used in the recording apparatus 2.

By inserting the positioning portions 182 of the non-reference side bearing member 80 into the first positioning hole 184, the second positioning hole 185, and the third positioning hole 186, the position of the non-reference side bearing member 80 in the roll setting portion 200 can be changed.

FIG. 12B is a view illustrating a state in which the non-reference side bearing member 80 is installed in the first positioning hole 184. In a case where the positioning portion 182 of the non-reference side bearing member 80 is inserted into the first positioning hole 184, the roll 201 having the maximum sheet width usable in the recording apparatus 2 can be set in the roll setting portion 200.

In a case where the positioning portion 182 of the non-reference side bearing member 80 is inserted into the second positioning hole 185, the roll 201 having a smaller sheet width than that in a case where the positioning portion 182 of the non-reference side bearing member 80 is inserted into the first positioning hole 184 can be set in the roll setting portion 200.

FIG. 12C is a view illustrating a state in which the non-reference side bearing member 80 is installed in the third positioning hole 186. In a case where the positioning portion 182 of the non-reference side bearing member 80 is inserted into the third positioning hole 186, the roll 201 having a smaller sheet width than that in a case where the positioning portion 182 of the non-reference side bearing member 80 is inserted into the second positioning hole 185 can be set in the roll setting portion 200.

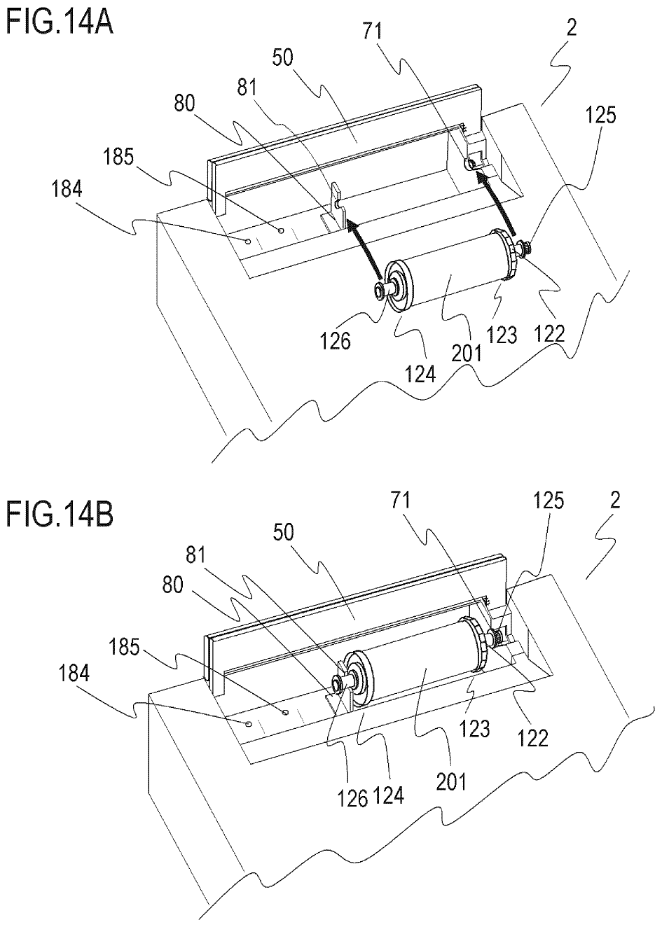

FIG. 14A is a view illustrating a state in which the roll 201 to which the reference side flange 123 and the non-reference side flange 124 are attached is set in the recording apparatus 2 in a case where the non-reference side bearing member 80 is attached to the third positioning hole 186. FIG. 14B is a view illustrating a state in which the roll 201 to which the reference side flange 123 and the non-reference side flange 124 are attached is set in the recording apparatus 2 in a case where the non-reference side bearing member 80 is attached to the third positioning hole 186.

The setting operation is similar to that in FIGS. 11A and 11B illustrating a state of the setting operation for the roll 201 in a case where the non-reference side bearing member 80 is attached to the first positioning hole 184. That is, the roll 201 is set in the roll setting portion 200 of the recording apparatus 2 such that the reference side bearing 71 supports the reference side shaft portion 122 and the non-reference side bearing 81 supports the non-reference side shaft portion 126. Since the same non-reference side bearing member 80 is used even when the sheet width is changed, the setting operation does not depend on the sheet width of the roll 201.

As illustrated in FIG. 14B, even in a state in which the roll 201 is set in the recording apparatus 2, the engagement state between the reference side shaft portion 122 and the reference side bearing 71 and the engagement state between the non-reference side shaft portion 126 and the non-reference side bearing 81 can be visually observed. Therefore, even in a state in which the reference side shaft portion 122 approaches the reference side bearing 71 and the non-reference side shaft portion 126 approaches the non-reference side bearing 81 during the setting operation, the user can easily visually recognize the reference side bearing 71 and the non-reference side bearing 81. Therefore, operability in alignment between the reference side shaft portion 122 and the reference side bearing 71 and alignment between the non-reference side shaft portion 126 and the non-reference side bearing 81 in the setting operation is favorable.

In the first embodiment, the positioning holes are provided at three different positions in the X direction (sheet width direction), and the positions of the positioning holes and the number of positioning holes can be arbitrarily set according to the sheet width of the roll 201 assumed to be used.

FIG. 13 is a view when viewed in a direction of an arrow B in FIG. 1B. FIG. 13 is a perspective view of a reference side portion of the roll setting portion 200 of the recording apparatus 2. The roll 201 to which the reference side flange 123 and the non-reference side flange 124 are attached is set in the roll setting portion 200 of the recording apparatus 2. Then, the reference side shaft portion 122 is rotatably supported by the reference side bearing 71, and the non-reference side shaft portion 126 is rotatably supported by the non-reference side bearing 81. In this state, the flange gear 125 meshes with the drive gear 72 provided in the apparatus body of the recording apparatus 2.

The drive gear 72 is connected to the roll drive motor 807 provided in the apparatus body of the recording apparatus 2. The driving force of the roll drive motor 807 is transmitted to the flange gear 125 via the drive gear 72 to rotate the reference side flange 123. As a result, the roll 201 and the non-reference side flange 124 rotate, and the sheet feeding operation from the roll 201 becomes possible.

In the recording apparatus 2 of the first embodiment, the non-reference side bearing member 80 can be installed at different positions in the sheet width direction. The roll 201 to which the reference side flange 123 and the non-reference side flange 124 are attached is rotatably supported by the reference side bearing 71 and the non-reference side bearing 81 of the non-reference side bearing member 80. As a result, the rolls 201 having a plurality of different sheet widths can be set in the roll setting portion 200 of the recording apparatus 2.

When attaching the reference side flange 123 to an end portion of the winding core 202 of the roll 201, the reference side end portion of the roll 201 is attached in a state of coming into contact with the flat reference side flange surface 131. As a result, a positional relationship between the reference side end portion of the roll 201 and the recording apparatus 2 can be made constant.

### Flange Determination Processing

In the recording apparatus 2 of the first embodiment, in the tension applying control, an amount related to the tension applied to the sheet 203 is detected, and determination processing of determining whether or not the reference side flange 123 is in the unlocked state is performed on the basis of a detected value. In other words, when the user attaches the reference side flange 123 to the roll 201, it is determined whether or not the cam member 160 has been moved from the first position P1 to the second position P2 to correctly bring the reference side flange 123 into the locked state. In a case where it is determined that the reference side flange 123 is in the unlocked state, a predetermined display is made on a display provided in the operation panel 6 to notify that the reference side flange 123 is in the unlocked state.

In the following description, a case where it is determined whether or not the reference side flange 123 is in the unlocked state will be described as an example, but in a configuration in which the driving force of the driving unit is input to the non-reference side flange 124, unlocked state determination for the non-reference side flange 124 can be similarly performed.

In the first embodiment, a torque output from the roll drive motor 807 is detected as the amount related to the tension applied to the sheet 203. The torque of the roll drive motor 807 is detected on the basis of a current value for driving the roll drive motor 807. The current value for driving the roll drive motor 807 is detected by the image recording control portion 404. That is, the image recording control portion 404 is a detection unit for detecting the amount related to the tension applied to the sheet 203.

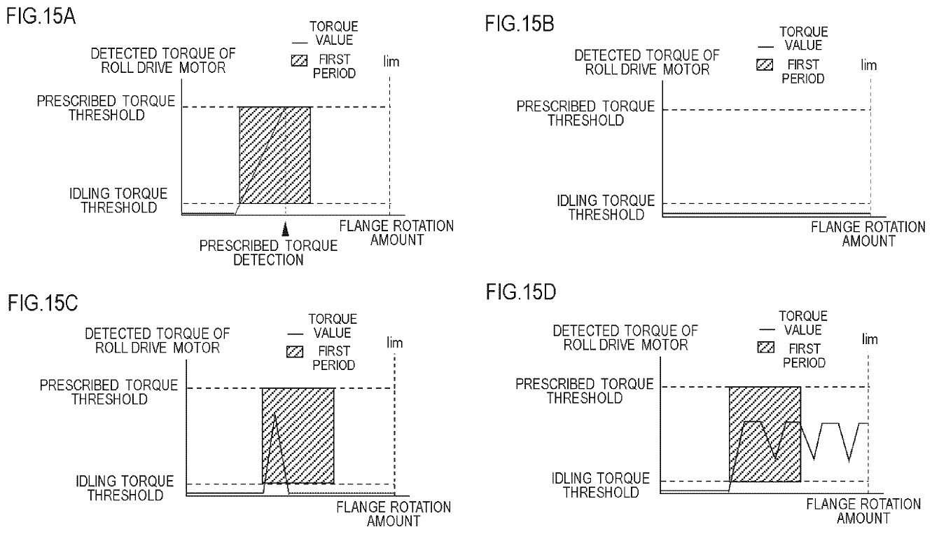

FIGS. 15A to 15D are graphs illustrating a torque change of the roll drive motor 807 in the tension applying control. A horizontal axis of the graph represents the rotation amount of the reference side flange 123 detected by the roll encoder 808. A vertical axis represents the torque measured by the current value of the roll drive motor 807. FIG. 15A is a graph illustrating a torque change in a case where the reference side flange 123 attached to the roll 201 is in the locked state in which the reference side flange 123 is normally fixed. FIG. 15B is a graph illustrating a torque change in a roll end state in which the remaining sheet 203 in the roll 201 has run out. FIG. 15C is a graph illustrating a torque change in a case where the roll 201 is unwound and is brought into the roll end state when the tension is applied to the sheet 203 by the tension applying control in a state immediately before the roll end state, in which about one turn of the sheet 203 remains on the winding core 202. FIG. 15D is a graph illustrating a torque change in a case where the reference side flange 123 attached to the roll 201 is in the unlocked state.

In the tension applying control, the convey roller 9 is stopped and the roll 201 is rotated in the reverse direction in a state in which a leading edge portion of the sheet 203 pulled out from the roll 201 set in the roll setting portion 200 is nipped between the convey roller 9 and the driven roller 10.

As illustrated in FIG. 15A, in a case where the reference side flange 123 is in the locked state, the tension applied to the sheet 203 increases as the roll 201 rotates in the reverse direction, and thus the torque of the roll drive motor 807 increases as a rotation amount of the roll 201 increases. When a detected value of the torque is equal to or larger than a prescribed torque threshold (equal to or larger than a second threshold), it can be determined that the prescribed tension has been applied to the sheet 203. That is, it can be determined that the reference side flange 123 is in the locked state (normal state). When the detected value of the torque is equal to or larger than the prescribed torque threshold, the roll drive motor 807 is stopped and the roll 201 is stopped, and thereafter, the rotation amount of the reference side flange 123 does not increase (is not updated).

The prescribed torque threshold is a threshold of the detected value of the torque for determining that the prescribed tension has been applied to the sheet 203. The prescribed torque threshold is determined on the basis of the torque applied to the roll drive motor 807 in a case where the sheet 203 is to be wound around the roll 201 with the prescribed tension applied to the sheet 203. The prescribed torque threshold is determined in consideration of various variations and the like so that the prescribed tension is reliably applied to the sheet 203 in the tension applying control.

As illustrated in FIG. 15B, in the roll end state, the roll 201 idles. The idling of the roll 201 means rotation of the roll 201 in a state in which the sheet 203 pulled out from the roll 201 is not nipped between the convey roller 9 and the driven roller 10 or in a state in which the sheet 203 is not wound. In a case where the roll 201 idles, a flange rotation amount is continuously updated while the torque of the roll drive motor 807 remains at a value equal to or smaller than an idling torque threshold (equal to or smaller than a first threshold). The idling torque threshold is a threshold of the detected value of the torque for determining that the roll 201 is idling. The idling torque threshold is determined on the basis of a torque (idling torque) for rotating (idling) the roll 201 in a state in which the roll 201 is set in the roll setting portion 200 and the sheet 203 is not nipped between the convey roller 9 and the driven roller 10. The idling torque threshold can be determined in consideration of the idling torque or the like in a case where the remaining amount of the roll 201 is maximum.

In a case where the roll 201 idles, the roll drive motor 807 is not stopped, and the rotation amount of the reference side flange 123 continues to increase (is updated). In a case where the rotation amount of the reference side flange 123 reaches a third threshold while the torque remains at a value equal to or smaller than the idling torque threshold, it can be determined that the roll end state has occurred. The third threshold is set in consideration of assumed slack of the sheet 203, a size and a paper type of the roll 201 to be mounted, an assumed user use method, and the like. In the first embodiment, the third threshold is, for example, a value corresponding to 1000 mm in terms of a conveyance amount of the roll 201. However, the third threshold is not limited thereto.

As illustrated in FIG. 15C, in a case where the roll 201 is unwound by the tension applying control in a state immediately before the roll end state, a torque that is less than the prescribed torque threshold and greater than the idling torque threshold is detected for a short period of time. Thereafter, the flange rotation amount may be continuously updated with a value equal to or smaller than the idling torque threshold.

As illustrated in FIG. 15D, in a case where the reference side flange 123 is in the unlocked state, the reference side flange 123 slides with respect to the winding core 202. Therefore, the driving force is not normally transmitted to the winding core 202, and the flange rotation amount is continuously updated while maintaining the detected value of the torque at a value larger than the idling torque threshold and smaller than the prescribed torque threshold. Even in the unlocked state, there is a frictional force between the inner peripheral surface of the winding core 202 and the first contact portion 136 and the second contact portion 137 of the reference side flange 123, and thus, the detected value of the torque is larger than the idling torque threshold. However, when a torque exceeding the frictional force is applied, the first contact portion 136 and the second contact portion 137 slide with respect to the inner peripheral surface of the winding core 202, so that the torque does not reach the prescribed torque threshold.

In the unwound state as illustrated in FIG. 15C, after the idling torque threshold is exceeded, the detected value of the torque is larger than the idling torque threshold and smaller than the prescribed torque threshold only for a short period of time, and thereafter, a value equal to or smaller than the idling torque threshold is maintained. In the unlocked state as illustrated in FIG. 15D, after the detected value of the torque exceeds the idling torque threshold, a state in which the detected value is larger than the idling torque threshold and smaller than the prescribed torque threshold continues. That is, in a certain period after the idling torque threshold is exceeded, it is not possible to distinguish between a case of the unwound state and a case of the unlocked state based on the detected value of the torque. Therefore, the unlocked state cannot be accurately determined.

Therefore, in the first embodiment, in order to discriminate between the unwound state and the unlocked state, a detected value in a first period after the detected value of the torque exceeds the idling torque threshold is not used for the determination. The first period can be determined on the basis of the rotation amount of the reference side flange 123 (the conveyance amount of the roll 201) required for the detected value of the torque to reach the prescribed torque threshold in the locked state and for the detected value of the torque to be stabilized at a value equal to or smaller than the idling torque in the unwound state. The first period can be determined according to the size and paper type of the roll 201, a rotation resistance of the apparatus, and the like. In the first embodiment, for example, the first period is set to a value corresponding to 50 mm in terms of the conveyance amount of the roll 201. However, the first period is not limited thereto.

As a result, a change in detected value of the torque in a short period of time as in FIG. 15C is not used for the determination, and the subsequent detected value of the torque is used for the determination, whereby the roll end state determination can be made. Specifically, in a case where the rotation amount of the reference side flange 123 has reached the third threshold while maintaining the detected value of the torque after the first period has elapsed at a value equal to or smaller than the idling torque threshold, it can be determined that the roll end state has occurred as a result of the unwinding. In a case where the detected value of the torque after the first period has elapsed is equal to or smaller than the idling torque threshold, it may be determined that the roll end state has occurred by the unwinding.

As illustrated in FIG. 15D, in a case where the detected value of the torque after the first period has elapsed is larger than the idling torque threshold and smaller than the prescribed torque threshold, it can be determined that the reference side flange 123 is in the unlocked state.

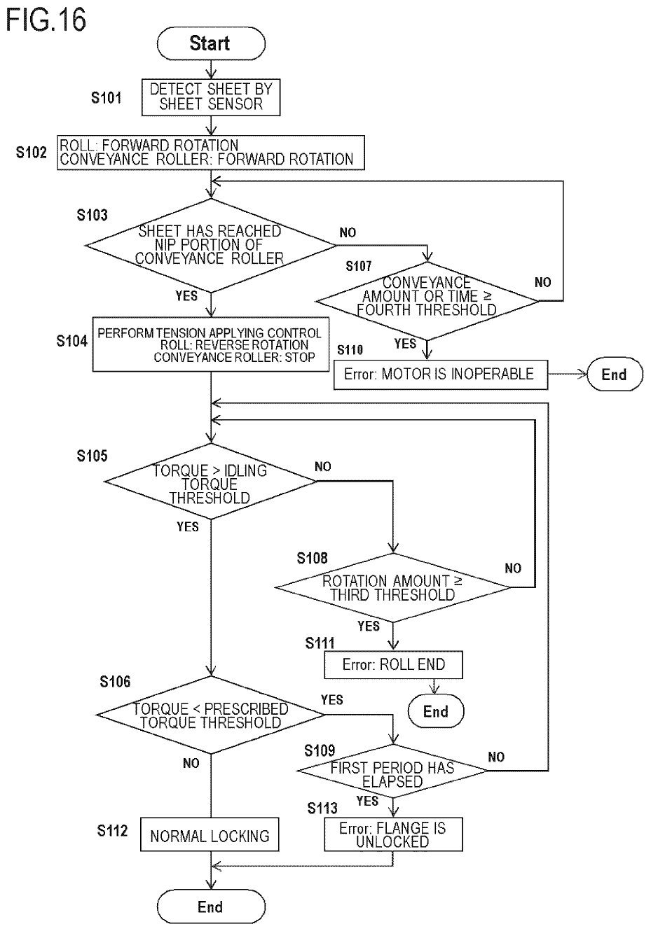

FIG. 16 is a flowchart of the determination processing of the first embodiment. The processing of the flowchart is performed by the control portion 402.

In step S101, the control portion 402 detects the leading edge of the sheet 203 by the sheet sensor 806. When the user manually feeds the sheet 203 and the leading edge of the sheet 203 reaches the position of the sheet sensor 806, the control portion 402 receives an output of the sheet sensor 806 and detects that the leading edge of the sheet 203 has reached the sheet sensor 806.

In step S102, the control portion 402 drives the roll drive motor 807 and the conveyance motor 51 so as to rotate the roll 201 in the forward direction and rotate the conveyance roller 9 in the forward direction.

In step S103, the control portion 402 determines whether or not the sheet 203 has reached the nip portion between the conveyance roller 9 and the driven roller 10. In a determination method, for example, a sheet sensor can be provided downstream of the conveyance roller 9 in the conveyance direction, and it can be determined that the sheet 203 has reached the nip portion in a case where the leading edge of the sheet 203 has been detected by the sheet sensor. In the case of a thick sheet, it can be determined that the sheet 203 has reached the nip portion by detecting displacement of the driven roller 10. In a case where the sheet 203 does not reach the nip portion (step S103: NO), the control portion 402 performs step S107, and in a case where the sheet 203 has reached the nip portion (step S103: YES), the control portion 402 performs step S104.

In step S107, the control portion 402 determines whether or not the conveyance amount or time from the start of the forward rotation of the roll 201 and the forward rotation of the conveyance roller 9 has reached a fourth threshold. In a case where the fourth threshold is reached (step S107: YES), the control portion 402 performs step S110, and in a case where the fourth threshold is not reached (step S107: NO), the control portion 402 returns to step S103. The fourth threshold can be determined on the basis of the conveyance amount or time assumed in a normal operation in which there is no abnormality in the roll drive motor 807 and the conveyance motor 51.

In step S110, the control portion 402 determines that at least one of the roll drive motor 807 and the conveyance motor 51 is inoperable, notifies of the inoperable state through the display of the operation panel 6, and ends the determination processing.

In step S104, the control portion 402 performs the tension applying control for the sheet 203. In the first embodiment, the tension applying control is performed by stopping the conveyance roller 9 and rotating the roll 201 in the reverse direction (driving the flange in a winding direction).

In step S105, the control portion 402 determines whether or not the detected value of the torque of the roll drive motor 807 is larger than the idling torque threshold. In a case where the detected value of the torque is larger than the idling torque threshold (step S105: YES), the control portion 402 performs step S106, and in a case where the detected value of the torque is equal to or smaller than the idling torque threshold (step S105: NO), the control portion 402 performs step S108.

In step S108, the control portion 402 determines whether or not the rotation amount of the reference side flange 123 is equal to or larger than the third threshold. The rotation amount of the reference side flange 123 can be acquired on the basis of an output of the roll encoder 808. In a case where the rotation amount of the reference side flange 123 is equal to or larger than the third threshold (step S108: YES), the control portion 402 performs step S111. In a case where the rotation amount of the reference side flange 123 has not reached the third threshold (step S108: NO), the control portion 402 returns to step S105.

In step S111, the control portion 402 determines that the roll end state has occurred, notifies of the occurrence of the roll end state through the display of the operation panel 6, and ends the determination processing.

In step S106, the control portion 402 determines whether or not the detected value of the torque of the roll drive motor 807 is smaller than the prescribed torque threshold. In a case where the detected value of the torque is smaller than the prescribed torque threshold (step S106: YES), the control portion 402 performs step S109, and in a case where the detected value of the torque has reached the prescribed torque threshold (step S106: NO), the control portion 402 performs step S112.

In step S112, the control portion 402 determines that the reference side flange 123 is in the locked state, notifies of the locked state through the display of the operation panel 6, and ends the determination processing.

In step S109, the control portion 402 determines whether or not the first period has elapsed since the detected value of the torque has exceeded the idling torque threshold. In a case where the first period has elapsed (step S109: YES), a state in which the detected value of the torque is larger than the idling torque threshold and smaller than the prescribed torque continues even after the first period has elapsed since the detected value of the torque has exceeded the idling torque threshold. In this case, the control portion 402 performs step S113. On the other hand, in a case where the first period has not elapsed (step S109: NO), the control portion 402 returns to step S105.

In step S113, the control portion 402 determines that the reference side flange 123 is in the unlocked state. The control portion 402 notifies of the unlocked state through the display of the operation panel 6, and ends the determination processing.

As a notification method, a method of making a notification by blinking of a lamp or sound of a buzzer can also be used in addition to a method of making a notification through the display of the operation panel 6 by characters, figures, and symbols. The tension applying control may be performed by a method of stopping the roll 201 and rotating the conveyance roller 9 in the forward direction (rotation in a direction in which the sheet 203 is pulled out from the roll 201) in a state in which the sheet 203 is nipped between the conveyance roller 9 and the driven roller 10. In other words, the conveyance roller 9 is rotated in a rotation direction in a case where the sheet 203 is conveyed in the conveyance direction when recording an image on the sheet 203. In this case, the determination processing can be performed on the basis of the detected value of the torque of the conveyance motor 51 and the conveyance amount by the conveyance motor 51.

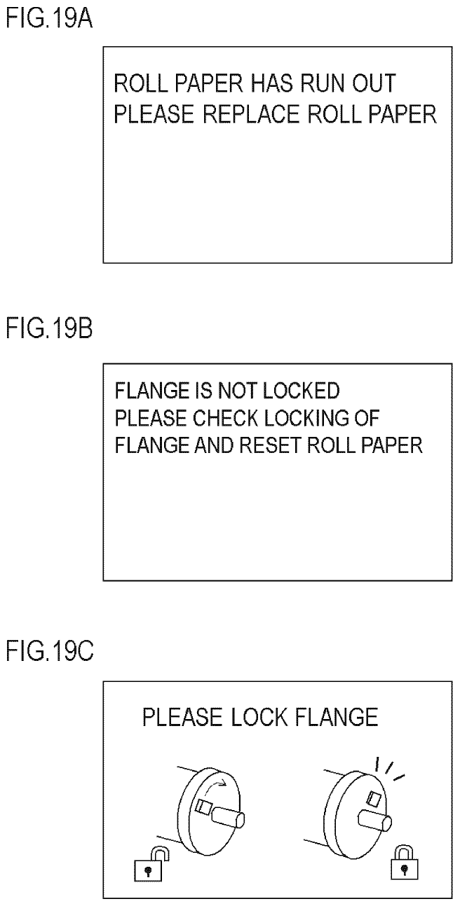

FIGS. 19A to 19C are views illustrating an example of a method of notifying of a determination result of the determination processing through the display of the operation panel 6.

FIG. 19A illustrates a screen display example in a case where it is determined that the roll end state has occurred by the determination processing (step S111). In this example, it is displayed that the roll needs to be replaced.

FIG. 19B illustrates a screen display example in a case where it is determined that the reference side flange 123 is in the unlocked state by the determination processing (step S113). In this example, a message indicating that the flange needs to be locked and prompting resetting of the roll is displayed.

FIG. 19C illustrates a screen display example for guiding a roll setting method and a flange locking method. In a case where the user confirms the notification of FIG. 19B and it is detected that the cover 50 has been opened to reset the roll, the notification of FIG. 19B is deleted, and transition to the display as illustrated in FIG. 19C is made, whereby a user operation can be supported.

The control portion 402 that performs the determination processing and the display of the operation panel 6 that displays notification contents based on the determination by the determination processing are notification units for making a notification based on the detected value of the amount related to the tension at the time of the tension applying control. The notification contents according to the determination result of the determination processing are merely examples, and the present disclosure is not limited to the examples. For example, in a case where it is determined that the holder is in the unlocked state, a notification of prompting the user to confirm a state of the holder (a state of the locking mechanism), such as “please check the holder”, may be given to the user.

### Second Embodiment

In the first embodiment, an example in which the torque measured on the basis of the current value for driving the roll drive motor 807 is detected as the amount related to the tension applied to the sheet 203 and used for the determination processing has been described. In the second embodiment, an example in which a rotation speed measured from an output of an encoder provided in a roll 201 or a conveyance roller 9 or a drive train thereof is detected as an amount related to a tension applied to a sheet 203 and used for determination processing will be described. In this case, constant current control is performed such that a constant torque is applied to a motor. In the second embodiment, an example in which a rotation speed of a reference side flange 123 is used for the determination processing will be described. A rotation speed of a roll drive motor 807 or a conveyance motor 51 or a rotation speed of the roll 201 can also be used as the rotation speed.

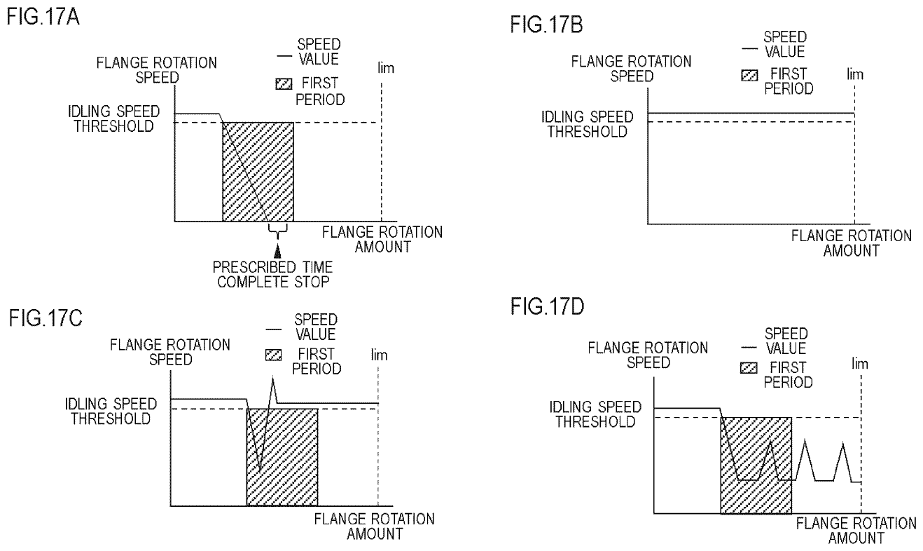

FIG. 17A is a graph illustrating a change in flange rotation speed in a case where the reference side flange 123 is in a locked state. FIG. 17B is a graph illustrating a change in flange rotation speed in a roll end state. FIG. 17C is a graph illustrating a change in flange rotation speed in a case where the roll 201 is unwound. FIG. 17D is a graph illustrating a change in flange rotation speed in a case where the reference side flange 123 is in an unlocked state.

As illustrated in FIG. 17A, in a state in which the reference side flange 123 is normally locked, as the tension is applied to the sheet 203 by tension applying control, the flange rotation speed decreases, and after a prescribed tension is applied, rotation of the reference side flange 123 is stopped. It can be determined that the tension is normally applied when a prescribed time has elapsed in a state in which the rotation is stopped. That is, it can be determined that the reference side flange 123 is in the locked state. The prescribed time can be determined on the basis of a time required for the prescribed tension to be securely applied to the sheet 203 after the rotation is stopped. The prescribed time can be determined in consideration of various variations and the like.

As illustrated in FIG. 17B, in the roll end state, a flange rotation amount is continuously updated with a value of the flange rotation speed that is equal to or larger than an idling speed threshold. The idling speed threshold is a threshold of the flange rotation speed for determining that the roll 201 is idling. The idling speed threshold can be determined on the basis of the flange rotation speed detected from an output of a roll encoder 808 when the roll drive motor 807 is subjected to constant current control in a state in which the sheet 203 is not nipped between the conveyance roller 9 and a driven roller 10. The idling speed threshold can be determined in consideration of an idling speed or the like in a case where the remaining amount of the roll 201 is maximum.

In a case where the roll 201 idles, the roll drive motor 807 is not stopped, and the rotation amount of the reference side flange 123 continues to increase (is updated). In a case where the rotation amount of the reference side flange 123 reaches a third threshold while the flange rotation speed remains at a value equal to or larger than the idling speed threshold, it can be determined that the roll end state has occurred.

As illustrated in FIG. 17C, in a case where the roll 201 is unwound by the tension applying control in a state immediately before the roll end state, the flange rotation speed lower than the idling speed threshold is detected for a short period of time. Thereafter, the flange rotation amount may be continuously updated with a value equal to or larger than the idling speed threshold. Further, the reference side flange 123 stops rotating. However, there may be a case where a state in which the rotation is stopped does not continue for the prescribed time, the reference side flange 123 starts rotating again, the idling speed threshold is reached, and thereafter, the flange rotation amount is continuously updated with a value equal to or larger than the idling speed threshold.

As illustrated in FIG. 17D, in a case where the reference side flange 123 is in the unlocked state, the reference side flange 123 slides with respect to the winding core 202. Therefore, the flange rotation amount is continuously updated while a driving force is not normally transmitted to the winding core 202, the flange rotation speed is lower than the idling speed threshold, and the rotation stop is not performed continuously for the prescribed time or more. Even in the unlocked state, there is a frictional force between an inner peripheral surface of the winding core 202 and a first contact portion 136 and a second contact portion 137 of the reference side flange 123, and thus, the flange rotation speed is lower than the idling speed threshold. However, when a torque exceeding the frictional force is applied, the first contact portion 136 and the second contact portion 137 slide with respect to the inner peripheral surface of the winding core 202, so that the rotation is not stopped, or even if the rotation is stopped, the rotation stop does not continue for the prescribed time.

In the case of an unwound state as illustrated in FIG. 17C, after a detected value of the flange rotation speed falls below the idling speed threshold, a state in which the flange rotation speed is lower than the idling speed threshold and the rotation is not stopped occurs only for a short period of time, and thereafter, a value equal to or larger than the idling speed threshold continues. In the unlocked state as illustrated in FIG. 17D, after the detected value of the flange rotation speed falls below the idling speed threshold, a state in which the flange rotation speed is lower than the idling speed threshold and the rotation is not stopped continues. That is, in a certain period after the flange rotation speed falls below the idling speed threshold, it is not possible to distinguish a case of the unwound state and a case of the unlocked state based on the detected value of the flange rotation speed. Therefore, the unlocked state cannot be accurately determined.

Therefore, in the second embodiment, in order to discriminate between the unwound state and the unlocked state, a detected value in a first period after the detected value of the flange rotation speed falls below the idling speed threshold is not used for the determination. The first period can be determined on the basis of the rotation amount of the reference side flange 123 (a conveyance amount of the roll 201) required for a state in which the reference side flange 123 stops rotating to continue for the prescribed time in the locked state and for the flange rotation speed to be stabilized at a value equal to or larger than the idling speed threshold in the unwound state.

As a result, a change in detected value of the flange rotation speed in a short period of time as in FIG. 17C is not used for unlocked state determination, and the subsequent detected value of the flange rotation speed is used for the determination, whereby roll end state determination can be made. Specifically, in a case where the rotation amount of the reference side flange 123 has reached the third threshold while maintaining the detected value of the flange rotation speed after the first period has elapsed at a value equal to or larger than the idling speed threshold, it can be determined that the roll end state has occurred as a result of the unwinding. In a case where the detected value of the flange rotation speed after the first period has elapsed is equal to or larger than the idling speed threshold, it may be determined that the roll end state has occurred by the unwinding.

As illustrated in FIG. 17D, in a case where the detected value of the flange rotation speed after the first period has elapsed is lower than the idling speed threshold and the rotation is not stopped for the prescribed time or more, it can be determined that the reference side flange 123 is in the unlocked state.

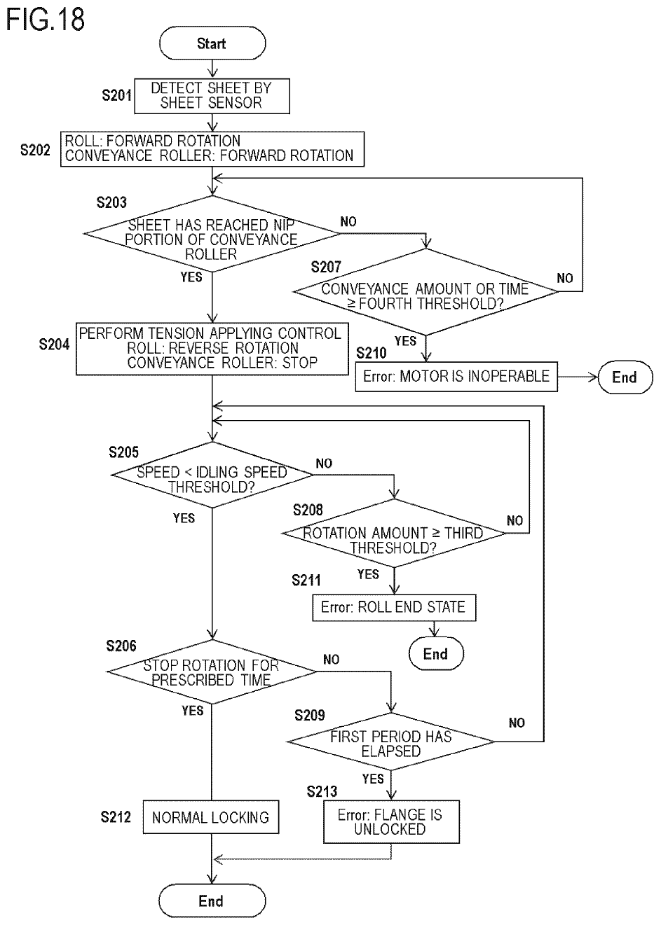

FIG. 18 is a flowchart of the determination processing of the second embodiment. The processing of the flowchart is performed by a control portion 402.

Since processing of steps S201 to S204, S207, and S210 is similar to processing of steps S101 to S104, S107, and S110 of the first embodiment, a description thereof will be omitted.

In step S205, the control portion 402 determines whether or not the detected value of the flange rotation speed has fallen below the idling speed threshold. In a case where the detected value of the flange rotation speed has fallen below the idling speed threshold (step S205: YES), the control portion 402 performs step S206. In a case where the detected value of the flange rotation speed has not fallen below the idling speed threshold (step S205: NO), the control portion 402 performs step S208.

Since processing of steps S208 and S211 is similar to processing of steps S108 and S111 of the first embodiment, a description thereof will be omitted.

In step S206, the control portion 402 determines whether or not the reference side flange 123 has stopped rotating and a state in which the reference side flange 123 has stopped rotating has continued for the prescribed time or more. In a case where the reference side flange 123 has stopped rotating for the prescribed time or more (step S206: YES), the control portion 402 performs step S212. In a case where the reference side flange 123 has not stopped rotating for the prescribed time or more (step S206: NO), the control portion 402 performs step S209.

Since processing of step S212 is similar to processing of step S112 of the first embodiment, a description thereof will be omitted.

In step S209, the control portion 402 determines whether or not the first period has elapsed since the detected value of the flange rotation speed has fallen below the idling speed threshold. In a case where the first period has elapsed (step S209: YES), the flange rotation speed falls below the idling speed threshold even after the first period has elapsed after the flange rotation speed has fallen below the idling speed threshold, and a state in which the rotation is not stopped for the prescribed time or more continues. In this case, the control portion 402 performs step S213. On the other hand, in a case where the first period has not elapsed (step S209: NO), the control portion 402 returns to step S205.

Since processing of step S213 is similar to processing of step S113 of the first embodiment, a description thereof will be omitted.

The tension applying control may be performed by a method of stopping the roll 201 and rotating the conveyance roller 9 in a forward direction (rotation in a direction in which the sheet 203 is pulled out from the roll 201) in a state in which the sheet 203 is nipped between the conveyance roller 9 and the driven roller 10. In this case, the determination processing can be performed on the basis of a speed value detected by an encoder sensor (not illustrated) attached to the conveyance roller 9 or the drive train (not illustrated).

### Third Embodiment

In the first and second embodiments, a method of determining the locked state (normal set state), the unlocked state, and the roll end state in a series of processes of the tension applying control for the roll 201 has been described. In a third embodiment, first, tension applying control is performed to determine whether or not a reference side flange 123 is in a locked state (normal set state), and in a case where it is determined that the reference side flange 123 is not in the locked state, the tension applying control is performed again to determine an unlocked state and a roll end state. In the third embodiment, similarly to the first embodiment, determination processing is performed using a detected value of a torque of a roll drive motor 807.

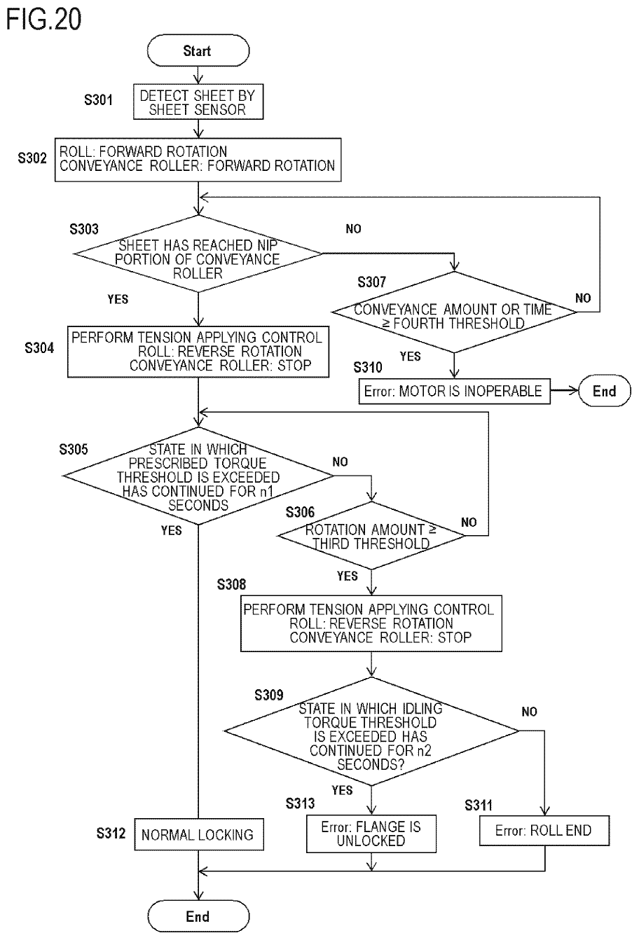

FIG. 20 is a flowchart of the determination processing of the third embodiment. The processing of the flowchart is performed by a control portion 402.

Since processing of steps S301 to S304, S307, and S310 is similar to processing of steps S101 to S104, S107, and S110 of the first embodiment, a description thereof will be omitted.

In step S305, the control portion 402 determines whether or not the detected value of the torque of the roll drive motor 807 is stably equal to or larger than a prescribed torque threshold. Specifically, it is determined whether or not a state in which the detected value of the torque is equal to or larger than the prescribed torque threshold has continued for a predetermined period (n1) or more. The predetermined period n1 can be set to about 1 second to 10 seconds in consideration of reliability, variation, and the like of numerical values, but is not particularly limited. In a case where the detected value of the torque is equal to or larger than the prescribed torque threshold continuously for the predetermined period n1 (step S305: YES), the control portion 402 performs step S312. In a case where the detected value of the torque is not equal to or larger than the prescribed torque threshold continuously for the predetermined period (step S305: NO), the control portion 402 performs step S306.

Since processing of steps S312 and 306 is similar to processing of steps S112 and 108 of the first embodiment, a description thereof will be omitted.

In a case where a rotation amount of the reference side flange 123 has reached a third threshold in step S306 (step S306: YES), the rotation amount reaches a limit rotation amount in a state in which the detected value of the torque is not equal to or larger than the prescribed torque threshold continuously for the predetermined period n1. In this case, since there is some error in a state of a roll 201, determination as to whether or not the reference side flange 123 is in the roll end state or the unlocked state is subsequently performed.

First, in step S308, the control portion 402 performs the tension applying control again. Contents of the tension applying control are similar to those in step S304.

In step S309, the control portion 402 determines whether or not the detected value of the torque is stably larger than an idling torque threshold. Specifically, it is determined whether or not a state in which the detected value of the torque is larger than the idling torque threshold has continued for a predetermined period (n2) or more. The predetermined period n2 can be set to about 1 second to 10 seconds in consideration of reliability, variation, and the like of numerical values, but is not particularly limited.

In a case where the detected value of the torque is equal to or larger than the idling torque threshold continuously for the predetermined period n2 (step S309: YES), the control portion 402 performs step S313 and determines that the reference side flange 123 is in the unlocked state. Step S313 is similar to step S113 of the first embodiment.

In a case where the detected value of the torque is not equal to or larger than the idling torque threshold continuously for the predetermined period n2 (step S309: NO), the control portion 402 performs step S311 and determines that the roll end state has occurred. Step S311 is similar to step S111 of the first embodiment.

### MODIFIED EXAMPLES

In each of the above embodiments, an example of the recording apparatus having a configuration in which the roll 201 can be set in the roll setting portion 200 by attaching the reference side flange 123 and the non-reference side flange 124 serving as the holders to both ends of the winding core 202 of the roll 201 has been described. The present disclosure is also applicable to a recording apparatus having a configuration in which a shaft member is inserted in the entire region of a winding core of a roll in a rotation axis direction, the shaft member is rotatably supported by an apparatus body of the recording apparatus, and the shaft member is driven by a motor. In this case, it is possible to determine that slippage is occurring between the shaft member and the winding core, notify of the slippage, and prompt a user to perform switching to the locked state in a case where there is a locking mechanism for fixing the shaft member to the winding core. In addition, also in a form in which a drive is transmitted by mounting or contact on an outer periphery of the roll, the present disclosure can be applied as a form in which conveyance slippage or the like between a drive member and the roll is detected. In this case, it is possible to notify the user of occurrence of the conveyance slippage between the roll and driving unit mounted on or coming into contact with the outer periphery, and to promote confirmation of a mounting state and maintenance of a contacting driver roller and the like.

In each of the above embodiments, an example in which the motor torque and the encoder speed are used as the detected value of the amount related to the tension has been described, but the present disclosure is not limited thereto. For example, a form in which a tensioner that comes into contact with a sheet is used, a form in which a speedometer using optical reflection such as a laser is used, a form in which a tension gauge is disposed with respect to a flange or a drive train in the middle, or the like may be used. In addition, the roller pair including the conveyance roller and the driven roller has been exemplified as the conveyance unit for conveying the sheet pulled out from the roll, but the conveyance unit is not limited to the roller pair and may be belt conveyance using a suction belt, for example.

According to the present disclosure, it is possible to provide a recording apparatus capable of prompting a user to take an appropriate measure in a case where a holder is not sufficiently fixed to a winding core.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-108864, filed on Jul. 5, 2024, which is hereby incorporated by reference herein in its entirety.

What is claimed is:

1. A recording apparatus that records an image on a sheet, the recording apparatus comprising:
a holder that is attached to a winding core of a roll around which the sheet is wound;
a locking mechanism that switches between a locked state in which the holder is fixed to the winding core and an unlocked state in which the holder is not fixed to the winding core;
a support unit for rotatably supporting the holder;
a conveyance unit for conveying the sheet pulled out from the roll supported by the support unit;
a detection unit for detecting an amount related to a tension applied to the sheet;
a control unit for performing drive control of rotation of the holder and driving of the conveyance unit so as to apply a prescribed tension to the sheet pulled out from the roll supported by the support unit; and
a notification unit for making a notification based on a detected value of the detection unit during the drive control.

2. The recording apparatus according to claim 1, wherein
the notification unit determines a state of the holder based on the detected value and makes a notification according to a result of the determination.

3. The recording apparatus according to claim 2, wherein
in a case where a threshold of the detected value for determining that the roll is idling is a first threshold, and
a threshold of the detected value for determining that the prescribed tension is applied to the sheet is a second threshold,
the notification unit determines that the holder is in the unlocked state in a case where the detected value after a first period has elapsed from a state where the detected value has exceeded the first threshold is larger than the first threshold and smaller than the second threshold.

4. The recording apparatus according to claim 3, wherein
the notification unit determines that the holder is in the locked state in a case where the detected value is equal to or larger than the second threshold.

5. The recording apparatus according to claim 3, wherein
the notification unit determines that a roll end state which is a state in which the sheet is not wound around the roll has occurred in a case where a rotation amount of the holder or a conveyance amount by the conveyance unit has reached a third threshold in a state in which the detected value is equal to or smaller than the first threshold after the first period has elapsed from a state where the detected value has exceeded the first threshold.

6. The recording apparatus according to claim 3, wherein
the notification unit determines that a roll end state which is a state in which the sheet is not wound around the roll has occurred in a case where a rotation amount of the holder or a conveyance amount by the conveyance unit has reached a third threshold in a state in which the detected value is equal to or smaller than the first threshold.

7. The recording apparatus according to claim 1, further comprising
a driving unit for rotationally driving the holder, wherein
the detection unit detects a torque output from the driving unit as the amount related to the tension.

8. The recording apparatus according to claim 1, further comprising
a driving unit for rotationally driving the holder, wherein
the detection unit detects, as the amount related to the tension, a rotation speed of the holder in a case where the driving unit is driven with a constant torque.

9. The recording apparatus according to claim 1, wherein
the conveyance unit includes a conveyance roller pair that nips the sheet.

10. The recording apparatus according to claim 9, wherein
the control unit performs the drive control in a state in which the sheet pulled out from the roll supported by the support unit is nipped by the conveyance roller pair.

11. The recording apparatus according to claim 9, wherein
in the drive control, the conveyance roller pair is stopped and the holder is rotated in a direction in which the sheet is wound around the roll in a state in which the sheet is nipped by the conveyance roller pair.

12. The recording apparatus according to claim 9, wherein
in the drive control, the conveyance roller pair is rotated in a direction in which the sheet is pulled out from the roll, and the holder is stopped in a state in which the sheet is nipped by the conveyance roller pair.

13. The recording apparatus according to claim 1, wherein
in a case where it is determined that the holder is in the unlocked state, the notification unit notifies that the holder is in the unlocked state and then makes a notification of prompting a user to operate the locking mechanism to bring the holder into the locked state.

14. The recording apparatus according to claim 1, further comprising
a display unit, wherein
the notification unit make a notification by performing predetermined display on the display unit.

15. The recording apparatus according to claim 1, wherein
the holder includes:
a core portion that is insertable into the winding core;
a contact portion that is made of an elastic body, is provided in the core portion, is movable to a pressing position where the contact portion comes into contact with an inner peripheral surface of the winding core and presses the inner peripheral surface radially outward, and a non-pressing position on a radially inner side of the pressing position;
a shaft portion that is rotatably supported by the support unit; and
a gear to which a driving force of driving unit for rotationally driving the holder is transmitted,
the locking mechanism includes a cam member that moves the contact portion between the pressing position and the non-pressing position,
in a case where the contact portion is moved to the pressing position by the cam member, the contact portion is pressed against the inner peripheral surface of the winding core to bring the holder into the locked state, and
in a case where the contact portion is moved to the non-pressing position by the cam member, the holder is brought into the unlocked state in which the contact portion is not pressed against the inner peripheral surface of the winding core.

16. A control method of a recording apparatus,
the recording apparatus comprising:
a holder that is attached to a winding core of a roll around which the sheet is wound;
a locking mechanism that switches between a locked state in which the holder is fixed to the winding core and an unlocked state in which the holder is not fixed to the winding core;
a support unit for rotatably supporting the holder;
a conveyance unit for conveying the sheet pulled out from the roll supported by the support unit; and
a detection unit for detecting an amount related to a tension applied to the sheet, wherein
the control method comprising:
a step of performing drive control of rotation of the holder and driving of the conveyance unit so as to apply a prescribed tension to the sheet pulled out from the roll supported by the support unit;
a detection step of detecting, by the detection unit, an amount related to the tension applied to the sheet during the drive control; and
a notification step of making a notification based on a detected value in the detection step.
